(19) United States
(12) Patent Application Publication
(10) Pub. No.: US 2013/0113952 A1
(43) Pub. Date: May 9, 2013

(54) INFORMATION PROCESSING APPARATUS, INFORMATION PROCESSING METHOD, AND PROGRAM

(71) Applicant: Sony Corporation, Tokyo (JP)

(72) Inventor: Tomonori Misawa, Tokyo (JP)

(73) Assignee: SONY CORPORATION, Tokyo (JP)

(21) Appl. No.: 13/661,887

(22) Filed: Oct. 26, 2012

(30) Foreign Application Priority Data
Nov. 7, 2011 (JP) 2011-243390

(51) Int. Cl. H04N 5/228

(52) U.S. Cl. 348/222.1; 348/E05.031

(57) ABSTRACT

There is provided an information processing apparatus including an image acquisition part acquiring a subject image obtained by capturing an image of a subject; an image analysis part analyzing an image capturing aspect of the subject in the subject image acquired by the image acquisition part; and a comment determination part determining, with respect to the image capturing aspect, a comment which is added to the subject image and displayed on a display screen based on an analysis result of the image analysis part.

### BACKGROUND

The present disclosure relates to an information processing apparatus, an information processing method, and a program.

Image capturing apparatuses are multi-functionalized in recent years and, for example, there is a technology for arranging and displaying a number of photographic images captured by the image capturing apparatus as thumbnail images. In such a technology, the plural thumbnail images are displayed into a matrix shape, for example.

Moreover, there is a technology described in Japanese Patent Application Publication 2011-013384 (hereinafter referred to as Patent Literature 1) not only for displaying photographic images but for stage-managing to allow perception of the feeling of persons and the like in the photographic images. This Patent Literature 1 describes an image processing apparatus which can automatically output voice comment data at a tempo and volume corresponding to the expression of the person in image data.

### SUMMARY

Incidentally, some image capturing apparatus captures and displays images of a subject automatically on a display screen. In such case, no change in image capturing aspects of the subject causes similar compositions in which the images are displayed on the display screen and thus leads to poorness in ideas.

It is desirable to propose a method capable of stage-managing rich in ideas when capturing and displaying images of a subject on a display screen.

According to an embodiment of the present disclosure, there is provided an information processing apparatus including an image acquisition part acquiring a subject image obtained by capturing an image of a subject, an image analysis part analyzing an image capturing aspect of the subject in the subject image acquired by the image acquisition part, and a comment determination part determining, with respect to the image capturing aspect, a comment which is added to the subject image and displayed on a display screen based on an analysis result of the image analysis part.

Further, according to an embodiment of the present disclosure, there is provided an information processing method, including acquiring a subject image obtained by capturing an image of a subject, analyzing an image capturing aspect of the subject in the subject image acquired, and determining, with respect to the image capturing aspect, a comment which is added to the subject image and displayed on a display screen based on an analysis result.

Further, according to an embodiment of the present disclosure, there is provided a program causing a computer to execute to acquiring a subject image obtained by capturing an image of a subject, analyzing an image capturing aspect of the subject in the subject image acquired, and determining, with respect to the image capturing aspect, a comment which is added to the subject image and displayed on a display screen based on an analysis result.

In addition, according to the present disclosure, an image capturing aspect of the subject in the subject image acquired is analyzed, and, with respect to the image capturing aspect, a comment added to the subject image and displayed on a display screen based on an analysis result is determined. Thereby, the subject sees the comment displayed on the display screen and changes the image capturing aspect, for example. By doing so, since composition of the subject will be changed in which composition an image is to be captured and displayed after that, the display which is rich in ideas can be performed.

As described above, according to the present disclosure, stage-managing rich in ideas can be performed when capturing and displaying images of a subject on a display screen.

### BRIEF DESCRIPTION OF THE DRAWINGS

FIG. 1 is a diagram illustrating an outline configuration of an image display system according to one embodiment;

FIG. 2 is a block diagram illustrating a configuration of the image display system according to one embodiment;

FIG. 3 is a block diagram illustrating a modification of the configuration of the image display system according to one embodiment;

FIG. 4 is a block diagram illustrating a detailed configuration of an image capturing apparatus according to one embodiment;

FIG. 5 is a block diagram illustrating a detailed configuration of a display apparatus according to one embodiment;

FIG. 6 is a diagram conceptually illustrating a virtual three-dimensional space in which subject images are arranged;

FIG. 7 is a diagram illustrating an example of displayed of a virtual three-dimensional space in which subject images are arranged as a two-dimensional image on a display screen;

FIG. 8 is a diagram illustrating a display example of a subject image to which a comment is added;

FIG. 9 is a block diagram illustrating a functional configuration of a display control apparatus;

FIG. 10 is a diagram for explaining subject images to which comments are added;

FIG. 11 is a diagram for explaining content of comments;

FIG. 12 is a schematic diagram illustrating a flow of comment determination processing by a comment determination part;

FIG. 13 is a diagram for explaining comment examples based on smile scores and generations;

FIG. 14 is a diagram for explaining a comment example based on face orientation;

FIG. 15 is a diagram for explaining a comment example based on positional relation between persons;

FIG. 16 is a schematic diagram illustrating time periods from a subject image having been captured until it is arranged in a virtual three-dimensional space;

FIG. 17 is a table illustrating relation of an age bracket of a user with a noticing time period and reaction;

FIG. 18 is a table illustrating relation of an age bracket of a user with a comment reading time period;

FIG. 19 is a flowchart illustrating comment display processing according to a subject;

FIG. 20 is a flowchart illustrating first comment determination process;

FIG. 21 is a schematic diagram illustrating faces of subjects of a comment determination object;

FIG. 22 is a flowchart illustrating comment determination process based on smile and generation;

FIG. 23 is a schematic diagram for explaining facial information FacialInfo;

FIG. 24 is a table illustrating a comment database;

FIG. 25 is a flowchart illustrating comment determination process based on face orientation;

FIG. 26 is tables illustrating a comment database.

FIG. 27 is a flowchart illustrating comment determination process based on face position;

FIG. 28 is a schematic diagram for explaining extraction of face numbers;

FIG. 29 is a flowchart illustrating identification processing of the subject to which the comment is attached; and

FIG. 30 is a schematic diagram for explaining CommentHolder[faceldx].

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Herein, descriptions will be made in the following order:

1. Configuration of Image Display System

2. Configuration of Image Capturing Apparatus

3. Configuration of Display Apparatus

4. Configuration of Display Control Apparatus
4-1. Comment Determination Processing
4-2. Acquisition Processing of Comment Display Time

5. Operation of Image Display System in Processing Comment Display
5-1. First Comment Determination Process
   5-1-1. Comment Determination Process Based on Smile and Generation
   5-1-2. Comment Determination Process Based on Face Orientation
5-2. Comment Determination Process Based on Face Position
5-3. Identification Processing of Subject to Which Comment Is Attached

6. Conclusion

### 1. CONFIGURATION OF IMAGE DISPLAY SYSTEM

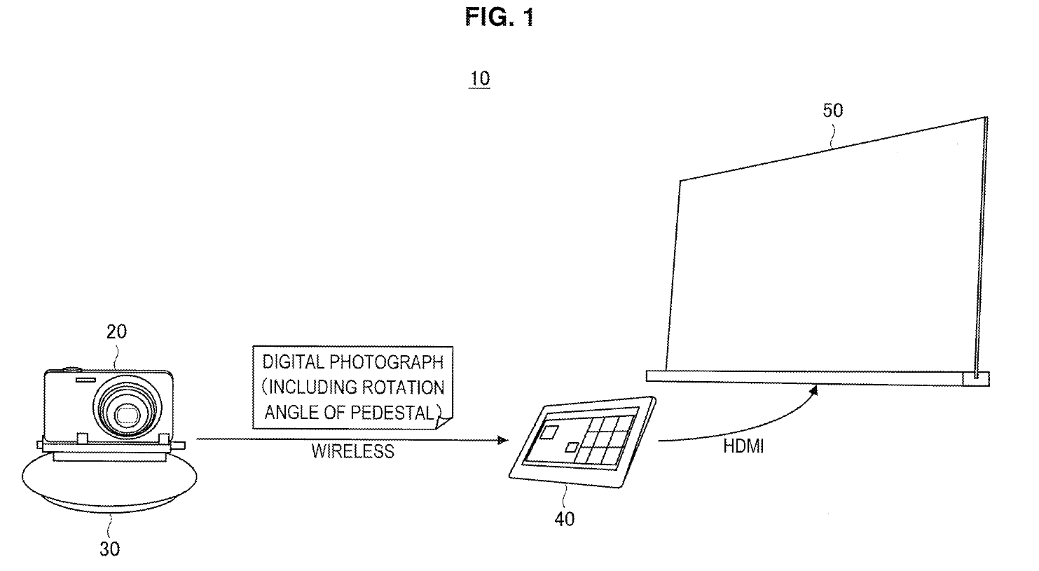

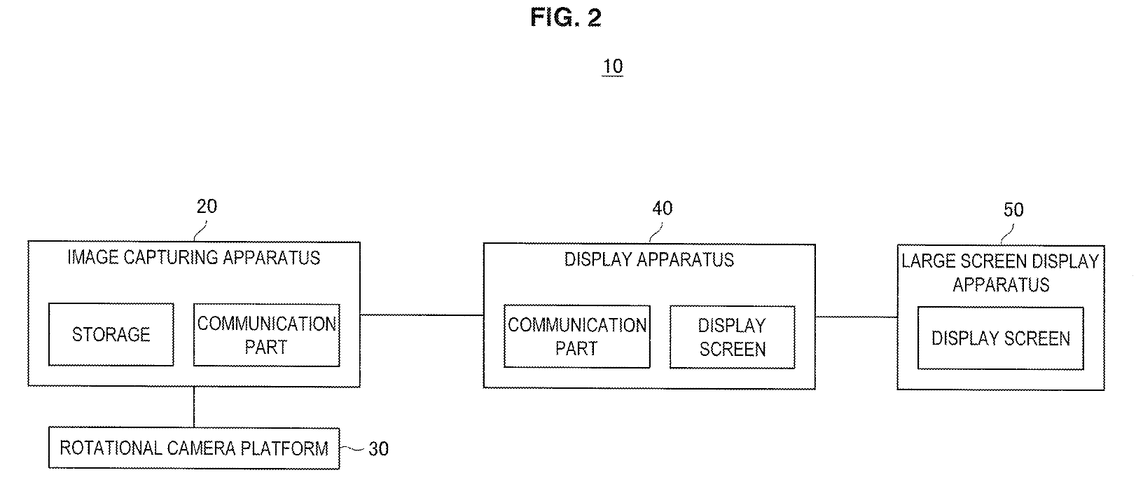

A configuration of an image display system 10 according to one embodiment of the present disclosure will be described referring to FIG. 1 and FIG. 2. FIG. 1 is a diagram illustrating an outline configuration of the image display system 10 according to one embodiment. FIG. 2 is a block diagram illustrating a configuration of the image display system 10 according to one embodiment.

The image display system 10 arranges captured subject images in a virtual three-dimensional space, and displays, as a two-dimensional image, the virtual three-dimensional space in which the subject images are arranged. As illustrated in FIG. 1 and FIG. 2, the image display system includes an image capturing apparatus 20, a rotational camera platform 30, a display apparatus 40 and a large screen display apparatus 50.

The image capturing apparatus 20 is a digital still camera, for example, and captures images of the subject. The image capturing apparatus 20 can also capture a panoramic image as one example of wide range images. The image capturing apparatus 20 can perform a function (party photographing function) in which, on the occasion of a gathering such, for example, as a party, the face of the subject is detected by automatically performing rotation (pan), angle adjustment (tilt) and zoom and its images are automatically captured. The image capturing apparatus 20 stores the captured images in a storage.

The rotational camera platform 30 is a camera platform rotatable by 360 degrees in the state where the image capturing apparatus 20 is situated thereon. The rotational camera platform 30 has an automatic tracking function of each motion of the pan, tilt and zoom and the face of the subject. By connecting the situated image capturing apparatus 20 to the rotational camera platform 30, the above-mentioned party photographing function is realized. In addition, in rotational camera platform 30, an operation part for the case of capturing the panoramic image may be provided.

The image capturing apparatus 20 can communicate with the display apparatus 40 via a wireless network or the like. Then, the image capturing apparatus 20 transmits the subject images captured automatically by the party photographing function (subject images stored in the storage) to the display apparatus 40. At this stage, the image capturing apparatus 20 also transmits information such as rotation angles of the rotational camera platform 30 in capturing the subject images as well as the subject images. In addition, the detailed configuration of the image capturing apparatus 20 is mentioned later.

The display apparatus 40 displays various images on a display screen, arranges the subject images received from the image capturing apparatus 20 (subject images captured automatically by the party photographing function) in the virtual three-dimensional space, and displays, as a two-dimensional image, the virtual three-dimensional space in which the subject images are arranged. The display apparatus 40 displays the virtual three-dimensional space on the display screen of the display apparatus 40 or on the large screen display apparatus 50 connected to the display apparatus 40. In addition, the details of the virtual three-dimensional space are mentioned later.

The large screen display apparatus 50 is connected to the display apparatus 40, and data is exchanged therebetween. The large screen display apparatus 50 displays, on its display screen, the virtual three-dimensional space in which the automatically captured subject images are arranged by the image capturing apparatus 20.

In addition, the image capturing apparatus 20 is supposed to be a digital still camera in the above description, but is not limited to this. The image capturing apparatus 20 only has to have a function for capturing images of the subject, and may be a mobile phone, a smart phone, a PDA (Personal Digital Assistant), a portable AV player, an electronic book, an electronic dictionary or the like, for example.

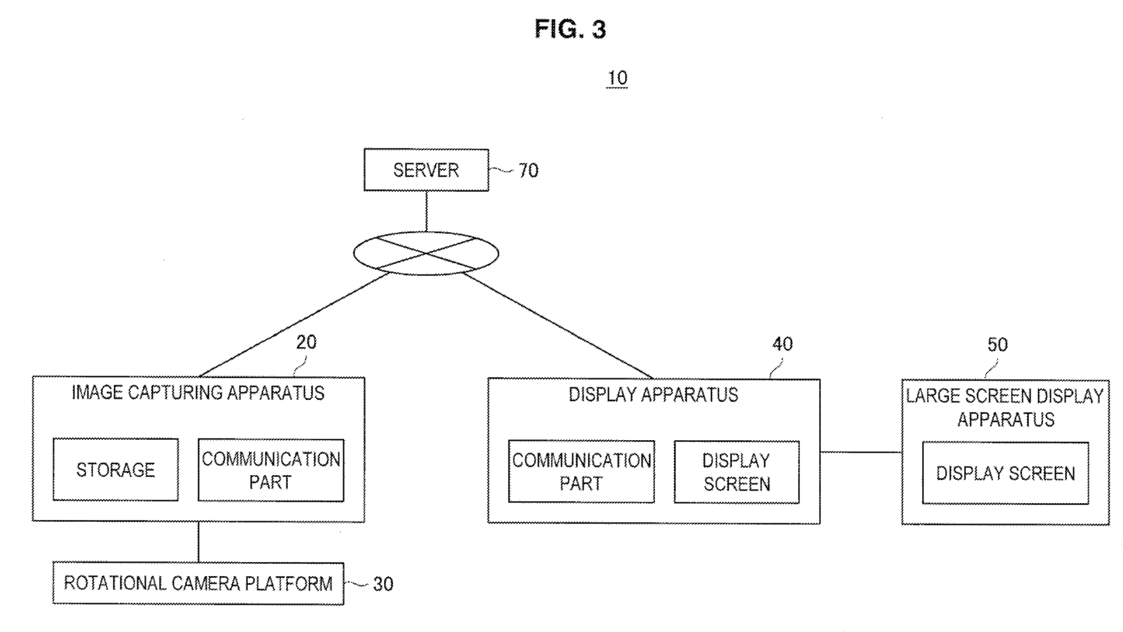

Moreover, the display apparatus 40 is supposed to receive the subject images arranged in the virtual three-dimensional space from the image capturing apparatus 20 in the above description, but is not limited to this. As illustrated in FIG. 3, for example, the display apparatus 40 may receive the subject images stored in a server, and arrange and display the subject images thus received in the virtual three-dimensional space.

FIG. 3 is a block diagram illustrating a modification of a configuration of the image display system 10 according to one embodiment. The image capturing apparatus 20 according to the modification in FIG. 3 transmits the subject images, which are captured automatically, to a server 70 via a wireless network or the like instead of the display apparatus 40. The server 70 stores the subject images received from the image capturing apparatus 20, and transmits the subject images to the display apparatus 40 in response to the demand from the display apparatus 40.

### 2. CONFIGURATION OF IMAGE CAPTURING APPARATUS

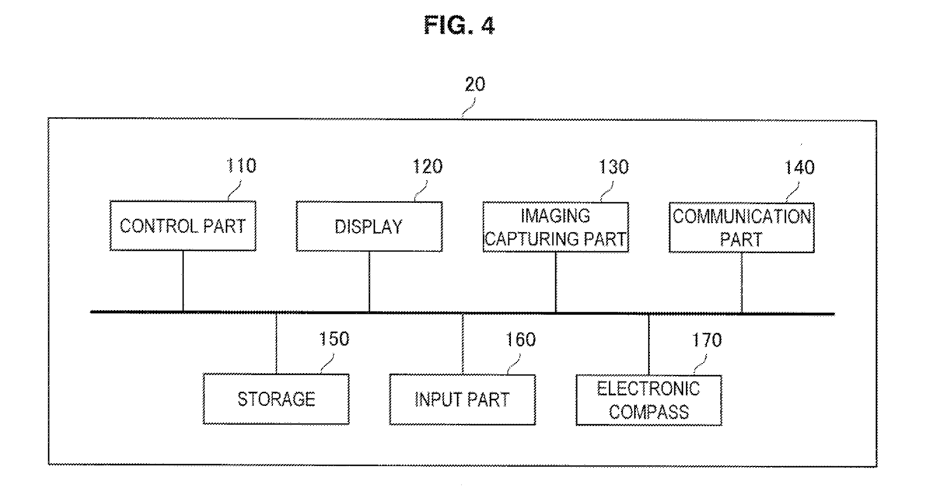

The detailed configuration of the image capturing apparatus 20 according to one embodiment of the present disclosure is described referring to FIG. 4. FIG. 4 is a block diagram illustrating the detailed configuration of the image capturing apparatus 20 according to one embodiment.

As illustrated in FIG. 4, the image capturing apparatus 20 includes a control part 110, a display 120, an imaging capturing part 130, a communication part 140, a storage 150, an input part 160 and an electronic compass 170.

The control part 110 exchanges signals between itself and each block of the image capturing apparatus 20 to perform various calculations, and controls the whole operation of the image capturing apparatus 20. The control part 110 includes a CPU, a ROM and a RAM, for example.

The display 120 is an LCD such as TFT (Thin Film Transistor) or an OELD (Organic Electro-Luminescence Display), for example, and displays various images on its display screen. The display 120 displays a preview image in capturing the image, for example.

The imaging capturing part 130 captures the subject images such as still images (photographs) and moving images with an image sensor such as CMOS (Complementary Metal Oxide Semiconductor) and CCD (Charge Coupled Devices) sensors, for example. The imaging capturing part 130 has a function of detecting the face of the subject. Moreover, the imaging capturing part 130 can capture a panoramic image. In addition, the imaging capturing part 130 captures a plurality of subject images automatically during execution of the party photographing function.

The imaging capturing part 130 can acquire not only the subject images but information on image capturing times and image capturing positions. The image capturing time is acquired from a clock (not shown) built in the image capturing apparatus 20. The time and date of the built-in clock may be corrected based on the time information received by a GPS sensor (not shown), for example, from GPS satellites.

The communication part 140 has a network interface card, a modem, or the like, for example, and performs communication processing between itself and other equipment via a network such as the Internet and a LAN (Local Area Network). The communication part 140 may include a wireless LAN module or a WWAN (Wireless Wide Area Network) module. The communication part 140 transmits the captured subject images and panoramic image to other equipment such as the display apparatus 40.

The storage 150 is a flash memory, for example, and stores the subject images captured by the imaging capturing part 130. Moreover, the storage 150 stores a control program which the control part 110 executes.

The input part 160 accepts an operation of a user and outputs an input signal to the control part 110. The input part 160 includes a power switch, a shutter release and the like, for example. The input part 160 may include a touch panel integrally provided with the display 120.

The electronic compass 170 includes a magnetic sensor detecting the earth magnetism which the earth emits, and calculates a direction (orientation) toward which the image capturing apparatus 20 faces based on the detected earth magnetism. The electronic compass 170 outputs the calculated orientation of the image capturing apparatus 20 to the control part 110.

### 3. CONFIGURATION OF DISPLAY APPARATUS

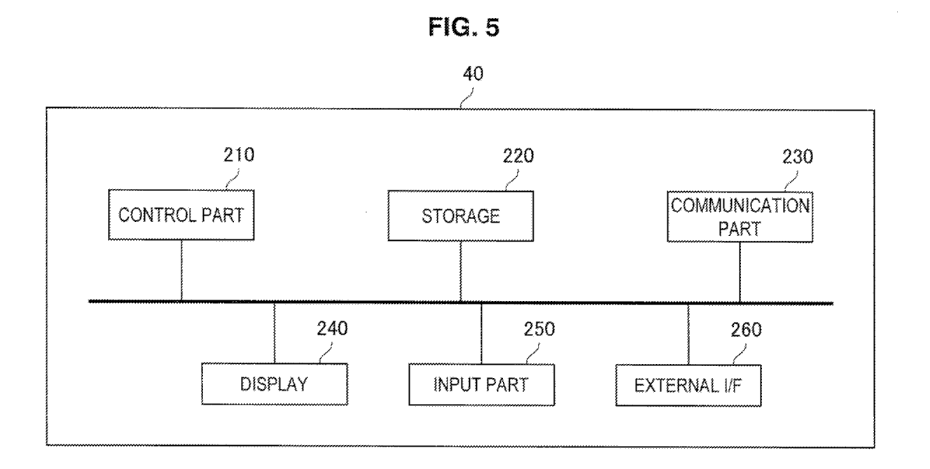

The detailed configuration of the display apparatus 40 according to one embodiment of the present disclosure will be described referring to FIG. 5. FIG. 5 is a block diagram illustrating the detailed configuration of the display apparatus 40 according to one embodiment.

As illustrated in FIG. 5, the display apparatus 40 includes a control part 210, a storage 220, a communication part 230, a display 240, an input part 250 and an external I/F (interface) 260.

The control part 210 exchanges signals between itself and each block of the display apparatus 40 to perform various calculations, and controls the whole operation of the display apparatus 40. The control part 210 performs processing such as arrangement of the subject images in the virtual three-dimensional space, the processing mentioned below. The control part 210 includes a CPU, a ROM and a RAM, for example.

The storage 220 is a flash memory and/or HDD (Hard Disk Drive), for example, and stores the subject images received from the image capturing apparatus 20. Moreover, the storage 220 stores the control program which the control part 210 executes.

The communication part 230 includes a network interface card, a modem, or the like, for example, and performs communications processing between itself and other equipment (the image capturing apparatus 20 and/or the server 70) via a network such as the Internet and a LAN (Local Area Network). The communication part 230 receives the subject images captured automatically by the image capturing apparatus from the image capturing apparatus 20 or the server 70 (also referred to as the image capturing apparatus 20 and the like).

The display 240 is an LCD or an OELD (Organic Electro-Luminescence Display) having TFT (Thin Film Transistor), for example. The display 240 arranges the subject images which the communication part 230 has received from the image capturing apparatus 20 in the virtual three-dimensional space, and displays, as a two-dimensional image, the virtual three-dimensional space in which the subject images are arranged on its display screen.

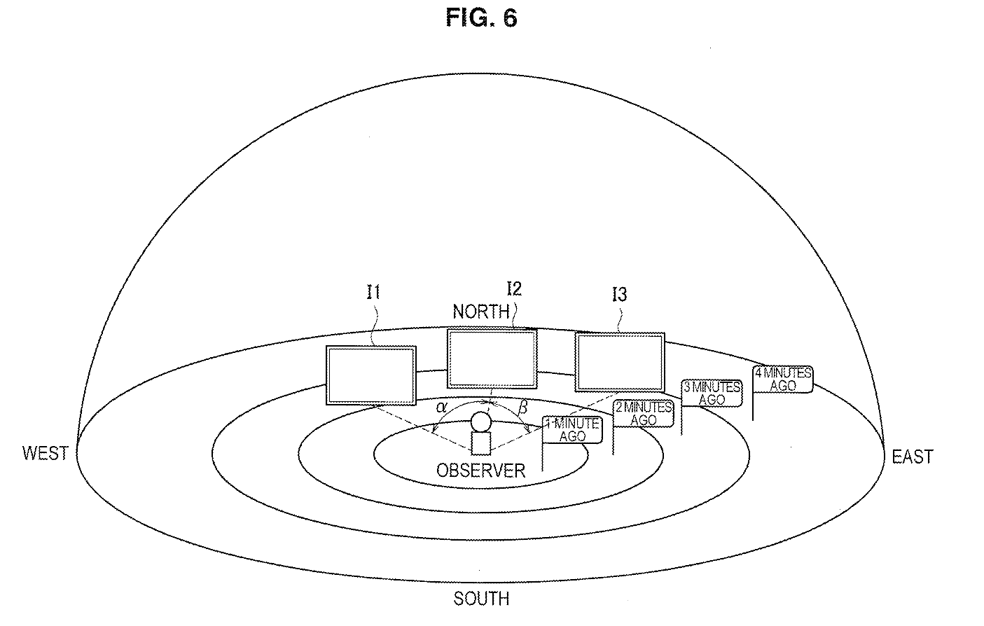

FIG. 6 is a diagram conceptually illustrating a virtual three-dimensional space in which subject images are arranged. As illustrated in FIG. 6, the virtual three-dimensional space is a virtual space which has a time axis corresponding to image capturing dates and times of the subject images in the radius direction of the circles with their center at the viewpoint of the user and which has an orientation axis corresponding to image capturing positions of the subject images in the circumferential direction of the circles.

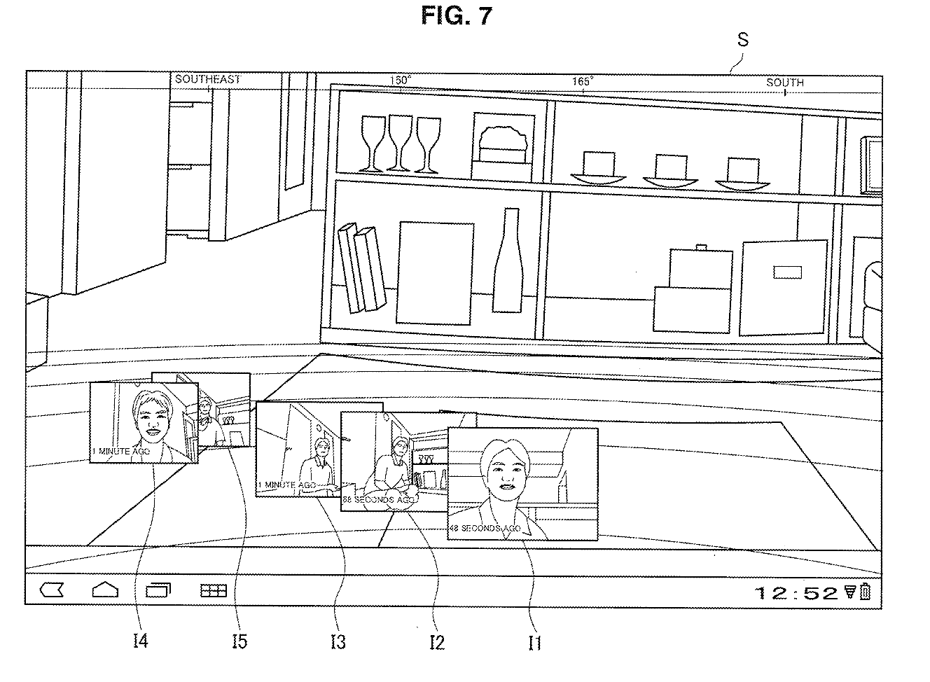

FIG. 7 is a diagram illustrating an example of displaying, as a two-dimensional image, the virtual three-dimensional space in which the subject images are arranged on a display screen S. The display 240 draws and displays the virtual three-dimensional space such that it is a scene seen from the viewpoint of the user. In FIG. 7, the horizontal axis, vertical axis and depth axis in the virtual three-dimensional space correspond to the orientation, altitude and time, respectively. Namely, the horizontal axis indicates the orientation of the place where the subject image has been captured, seen from the current position of the image capturing apparatus 20. The depth axis indicates the date and time when the subject image has been captured, seen from the current date and time. The vertical axis indicates the altitude of the place from the surface of the earth where the subject image has been captured.

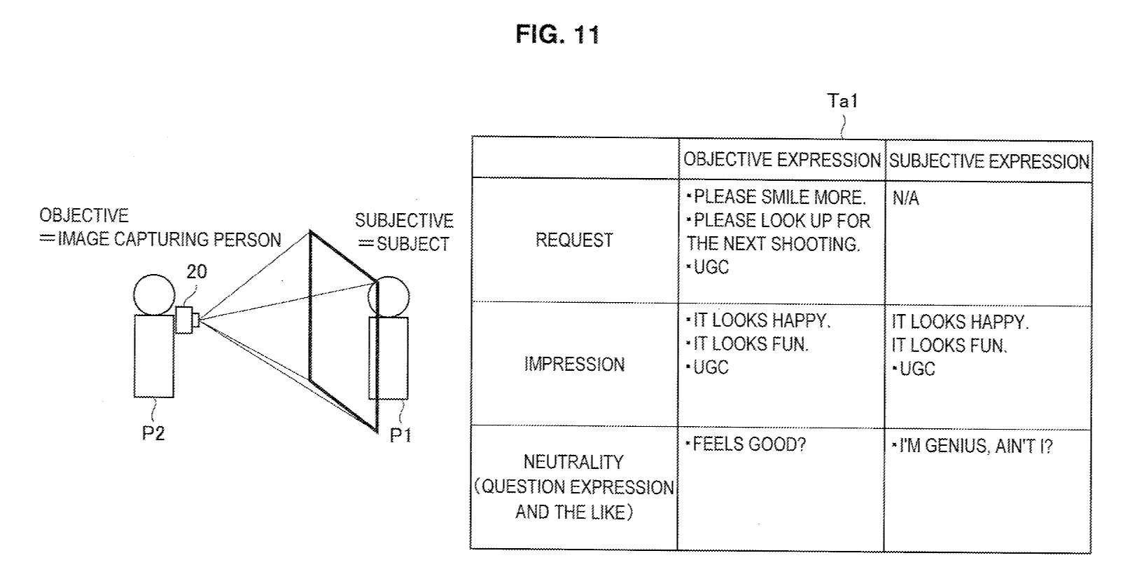

In FIG. 7, five subject images 11 to 15 which are different in image capturing date and time and are captured from different orientations are arranged in the virtual three-dimensional space and displayed as a two-dimensional image. Moreover, the virtual three-dimensional space illustrated in FIG. 11 has depth perception in the depth direction, and the sizes of the subject images are different according to the distances of the subject images from the current position. Namely, the subject image 11 which is nearest to the current position is the largest and the subject image 15 which is most separated from the current position is the smallest. In addition, the virtual three-dimensional space may not have the depth perception in the depth direction, or the sizes of the subject images 11 to 15 may be the same size. By displaying in this way, the user can grasp relation of the image capturing positions with the image capturing dates and times of the plural subject images easily.

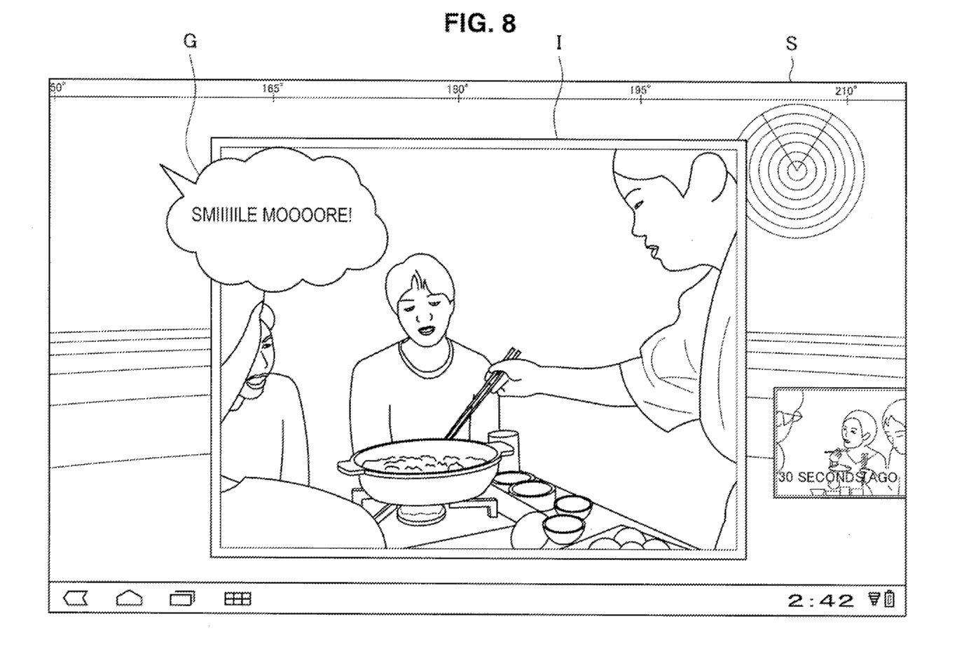

Before arranging the subject image in the virtual three-dimensional space, the display 240 enlarges and displays the subject image concerned for a predetermined time, as illustrated in FIG. 8. At this stage, the display 240 adds a balloon G with a comment (“Smiiiiile Moooore!”) to the subject image to display it. FIG. 8 is a diagram illustrating a display example of the subject image to which the balloon G with the comment is added. In addition, when one subject image is selected from the plural subject images illustrated in FIG. 7 by the user, the display 240 adds a comment to the selected subject image to display as illustrated in FIG. 8.

The input part 250 is a touch panel integrally provided with the display 240, for example. In the state where an image or GUI (Graphical User Interface) is displayed by executing an image display application, for example, the input part 250 detects a touch operation of the user to output to the control part 210. Moreover, the touch panel is used for the user selecting an image to perform entire screen display or moving a viewpoint (zoom-in or zoom-out) during the execution of the image display application.

The external I/F 260 connects with external equipment (for example, the large screen display apparatus 50) in conformity with various standards such as HDMI (High-Definition Multimedia Interface) and USB (Universal Serial Bus), for example, and exchanges data therebetween. For example, the display apparatus 40 transmits the subject images and panoramic image which are displayed on the display screen of the large screen display apparatus 50 via the external I/F 260.

### 4. CONFIGURATION OF DISPLAY CONTROL APPARATUS

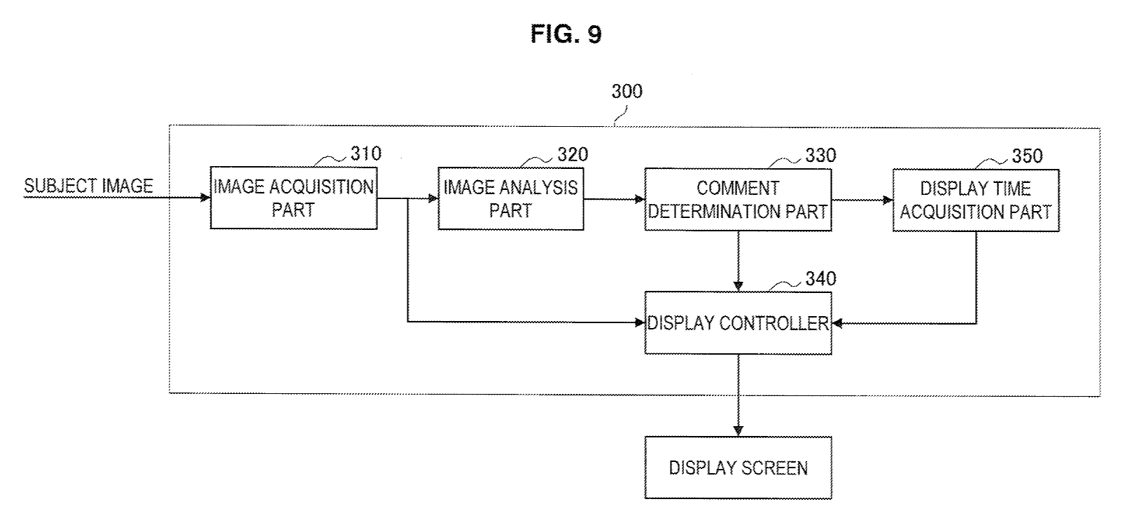

Referring to FIG. 9, a functional configuration of a display control apparatus 300 which is one example of an information processing apparatus which controls image display in the image display system 10 will be described. FIG. 9 is a block diagram illustrating the functional configuration of the display control apparatus 300.

The display control apparatus 300 performs control so as to determine comments with respect to subject images captured by the image capturing apparatus 20 and attach the comments thus determined to the subject images to display. As illustrated in FIG. 9, the display control apparatus 300 includes an image acquisition part 310, an image analysis part 320, a comment determination part 330, a display controller 340 and a display time acquisition part 350. In addition, the image acquisition part 310, image analysis part 320, comment determination part 330, display controller 340 and display time acquisition part 350 are realized due to functions of the control part 210 of the display apparatus 40, for example.

The image acquisition part 310 acquires subject images obtained by capturing images of the subject. For example, the image acquisition part 310 acquires a subject image from the image capturing apparatus 20 or the server 70. The subject image is captured by the image capturing apparatus which is situated on the rotational camera platform 30 which can rotate freely and rotates interlockingly with the rotation of the rotational camera platform 30. In addition, when plural subject images have been captured automatically by the image capturing apparatus 20, the plural subject images are acquired sequentially. One subject image thus acquired may be an image in which images of plural subjects are captured.

The image acquisition part 310 acquires image capturing date and time information which indicates image capturing dates and times of the subject images and image capturing position information which indicates image capturing positions of the subject images in acquiring the subject images. The image acquisition part 310 acquires the image capturing date and time information and the image capturing position information in association with the subject images. The image acquisition part 310 outputs the acquired image to the image analysis part 320 and display controller 340.

The image analysis part 320 analyzes the image inputted from the image acquisition part 310. For example, the image analysis part 320 analyzes image capturing aspects of the subject in the subject image acquired by the image acquisition part 310. The image capturing aspects include a plurality of aspects such as a smile score of the subject, an orientation to which the subject faces, and positional relations between the plural subjects, for example. Moreover, the image analysis part 320 analyzes the number of the subjects (persons) in the subject image. Furthermore, the image analysis part 320 analyzes the age of the subject, and decides to which one of the plural age brackets categorized beforehand the age corresponds. The image analysis part 320 outputs analysis information as analysis results to the comment determination part 330.

The comment determination part 330 determines a comment to be attached to the subject image as the analysis object based on the analysis information inputted from the image analysis part 320. The comment determination part 330 determines a comment to the subject side and/or a comment from the subject side with respect to the image capturing aspects of the subject. Moreover, the comment determination part 330 determines a comment for each subject in the subject image obtained by capturing the image of the plural subjects. In addition, the comment to the subject side is a comment made for the subject or a comment of thought on the subject, for example. On the other hand, the comment from the subject side is a comment made by the subject or a comment which the subject thinks, for example.

For example, the comment determination part 330 can determine the comment according to the smile score of the subject, the orientation to which the subject faces, the age of the subject, and the age bracket to which the subject corresponds. Moreover, the comment determination part 330 can determine the comment according to the positional relation when the positional relations between the plural subjects in one subject image are in a predetermined range. Furthermore, the comment determination part 330 can convert degrees of the plural aspects into individual scores, and determine the comment relevant to the largest aspect in score from among the plural aspects. Thereby, the suitable comment according to the aspects of the subject is to be determined.

The comment determination part 330 outputs the comment thus determined to the display controller 340 and display time acquisition part 350. In addition, details of the comment determination processing performed by the comment determination part 330 are mentioned later.

The display controller 340 displays the subject image inputted from the image acquisition part 310 on the display screen. For example, the display controller 340 displays the subject image to which the comment is added at a predetermined drawing position in the virtual three-dimensional space. By performing such display, even when automatically captured images are displayed sequentially on the display screen, they can be enjoyed and not boring.

When displaying the subject images on the display screen sequentially, the display controller 340 adds the comments determined by the comment determination part 330 to the subject images to display. For example, the display controller 340 performs the display such that the comments are arranged in the balloons (refer to FIG. 8). Moreover, the display controller 340 adds and displays the determined plural comments for the respective corresponding subjects. Thereby, the subject sees the comments displayed on the display screen and changes the image capturing aspects, for example. By doing so, since the compositions of the subject will be changed in which compositions images are to be captured and displayed sequentially after that, the display which is rich in ideas can be performed. In addition, comments of the image capturing person side can include content of a request for posing and/or expression next in capturing an image, for example.

The display time acquisition part 350 acquires a display time for which the comments determined by the comment determination part 330 are added to the subject images to be displayed. For example, the display time acquisition part 350 acquires the display time for which the subject images to which the comments have been added are displayed according to the age bracket to which the subject corresponds. Thus, since the display time is configured according to the age bracket or the like of the user who sees the display screen, the user can grasp the comments appropriately.

Herein, the display time is a time obtained by adding a first time expected until the user who sees the display screen notices the displayed comment, a second time for which the user reads the comment, and a third time for which the user performs reaction with respect to the comment, for example. In addition, when plural balloons G (comments) are attached to one subject image, the display time is a time obtained by adding first times to third times for the plural comments. The display time acquisition part 350 outputs the display time thus acquired to the display controller 340. In addition, details of the acquisition processing of the display time are mentioned later.

### (4-1. Comment Determination Processing)

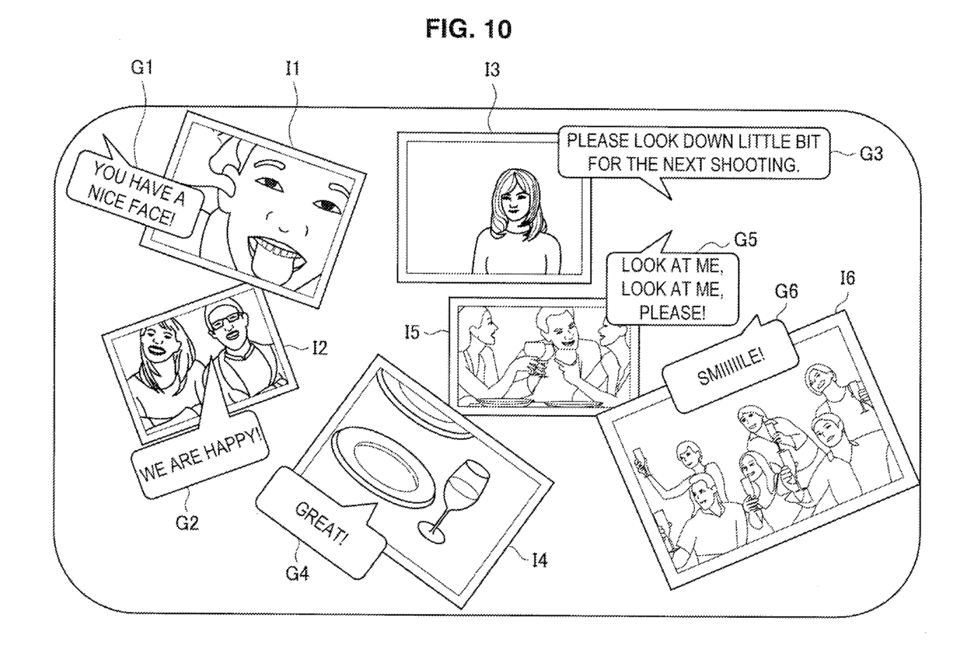

Details of the comment determination processing by the comment determination part 330 are described referring to FIG. 10 to FIG. 15.

FIG. 10 is a diagram for explaining subject images to which comments are added. In FIG. 10, different comments are added to individual subject images 11 to 16. The added comments include content reflecting the expressions of persons in the images, the image capturing scenes and the like. In addition, the subject images to which the comments illustrated in FIG. 10 are displayed on the display screen one by one actually.

In FIG. 10, the balloons G are drawn near the faces of the subjects. Moreover, to one subject image, one comment (balloon G) is added whereas the number of balloons is not limited to one. The balloons whose number corresponds to the number of persons in the image can be displayed. For example, when there are two persons in the image, the balloon is displayed for each person. However, since too many balloons make the image hardly seen, the maximum number of balloons may be configured.

FIG. 11 is a diagram for explaining content of the comments. The determined comments are roughly categorized into subjective expressions and objective expressions. Herein, the subjective expression is a comment from the person P1 side which person is the subject captured. The objective expression is a comment on the image capturing person P2 side which person captures an image of the subject (in other words, a comment from the image capturing person P2 to the subject side). And any comment of the subjective expression and objective expression is selected to be added to the subject image. In addition, the comments present character information whereas they may include figures or the like.

In addition, selection from the objective expressions and subjective expressions is performed by the comment determination part 330 as follows. For example, the comment determination part 330 may perform the selection from the comments in subjective expression and the comments in objective presentation randomly, or may perform the selection from the comments in subjective expression and the comments in objective presentation alternately. At this stage, the comment determination part 330 can perform the selection such that a difference between the number of the displayed comments in subjective expression and the number of the displayed comments in objective expression does not exceed a predetermined number. Moreover, the comment determination part 330 may perform the selection of the comment in subjective expression when the area of the face of the subject in the image is larger than a predetermined area, and the selection of the comment in objective expression when the area of the face is smaller than a predetermined area. Furthermore, the comment determination part 330 may perform the selection of the comment in subjective expression when the orientation of the face of the subject in the image is within a predetermined orientation range, and the selection of the comment in objective expression when the orientation of the face is out of the predetermined orientation range. By employing the above-mentioned methods of selection, the display which is rich in ideas can be performed.

Incidentally, as illustrated in FIG. 10, the position of the reference point of the comment in subjective expression is different from the position of the reference point of the comment in objective expression. Specifically, the reference points of the balloons G2 and G4, which include the comments in subjective expression, locate inside the subject images I2 and I4, and the reference points of the balloons G1, G3, G5, and G6, which include the comments in objective expression, locate outside the subject images I1, I3, I5, and I6. Thus, discrimination between the positions of the balloons of the comments in subjective expression and the comments in objective expression facilitates perception of the subjective expression or objective expression when seeing the comments in the display screen.

Moreover, as illustrated in a table Ta1 in FIG. 11, the content of the comments is categorized into the subjective expressions and objective expressions, and is further categorized into content of requests, content of impressions and content of neutrality. In addition, the comments in the table are created beforehand. Moreover, UGC (User Generated Content) in the table denotes a comment which the user newly creates.

FIG. 12 is a schematic diagram illustrating a flow of the comment determination processing by the comment determination part 330. The comment determination processing includes five steps as illustrated in FIG. 12. In addition, the case where the comment in objective expression is determined is described below.

In the first step, the comment determination part 330 categorizes the subject images according to the number of person included in one subject image. Specifically, the comment determination part 330 categorizes them into images IM1 in which there is one person, images IM2 in which there are two or three persons, images IM3 in which there are four or more persons and images IM4 in which there is no person. In addition, no person means that it is detected that there is no person in the image and, also, that the presence or absence of persons is difficult to be detected.

In the second step, the comment determination part 330 determines the comments according to the categorized images. Specifically, the comment determination part 330 determines the comments with respect to the images IM1 in which there is one person, the images IM2 in which there are two or three persons and the images IM3 in which there are four or more persons based on smile scores (SmileScore) and generations (GenerationScore).

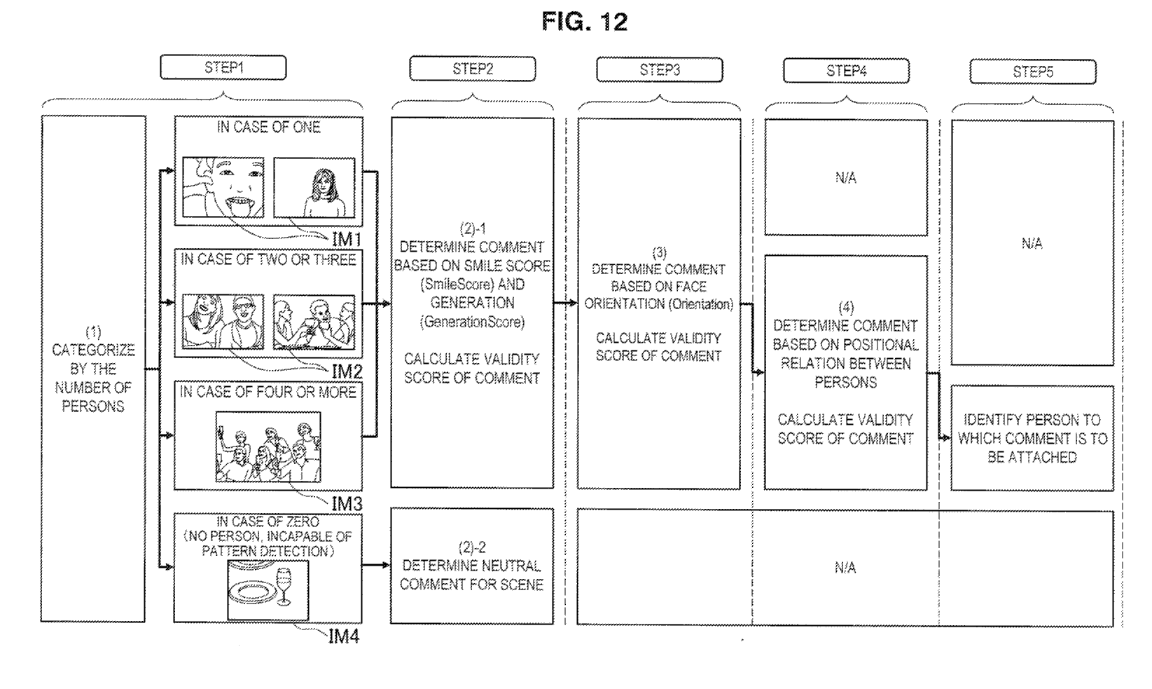

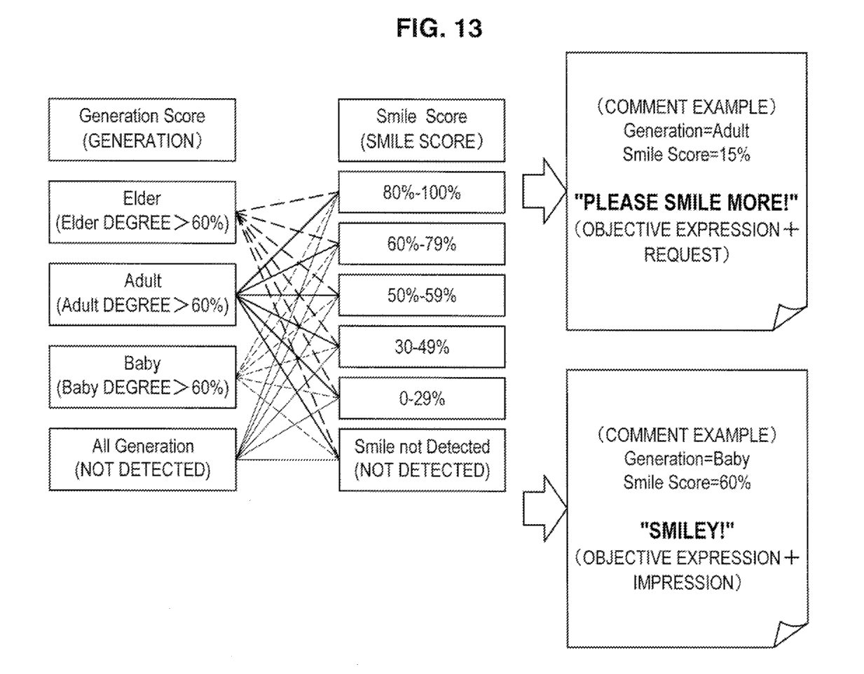

FIG. 13 is a diagram for explaining comment examples based on the smile scores and generations. As illustrated in the comment example in FIG. 13, the comments are determined based on combinations of the smile scores (SmileScore) and generations (GenerationScore). Herein, the smile scores are categorized into six sections. The generations are categorized into an elderly person (Elder), an adult (Adult), a child (Baby) and no detection (All Generation). In addition, when a possibility in which there is relevancy for matching a certain generation is higher than 60%, it is decided that there is the relevancy for matching the certain generation.

For example, when the generation is the adult and the smile score is 15%, the comment “Please smile more!” is determined. Moreover, when the generation is the child and the smile score is 60%, the comment “Smiley!” is determined. Herein, since the generation is the child, the comment is configured to be easily understandable. In addition, the comment corresponding to the combination of the smile score (SmileScore) and the generation (GenerationScore) is selected from a plurality of comments randomly.

In the second step illustrated in FIG. 12, with respect to the images IM4 in which there is no person, the neutral comment is determined corresponding to the image capturing scene. In addition, with respect to the images IM4 in which there is no person, the third to fifth steps mentioned below are not performed.

In the third step, the comment determination part 330 determines the comments with respect to the images IM1 in which there is one person, the images IM2 in which there are two or three persons and the images IM3 in which there are four or more persons based on face orientations (Orientation). Specifically, the comment according to combinations of the generations and face orientations are determined. In addition, the face orientation is decided based on the face orientation in directions of three axes which cross one another perpendicularly (directions of Yaw, Roll and Pitch).

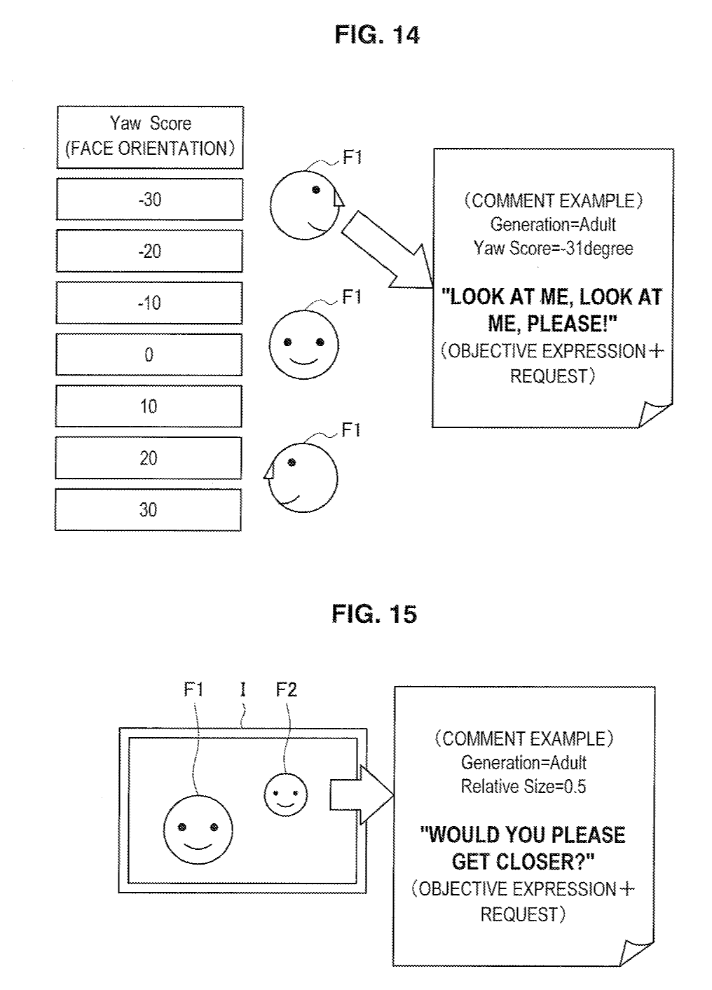

FIG. 14 is a diagram for explaining a comment example based on the face orientation. Herein, the face orientation is described exemplarily in the direction of one axis of the above-mentioned three axes which cross one another perpendicularly (Yaw direction). In FIG. 14, a YawScore is configured according to which orientation (right, left or front) the face faces. The YawScore is configured as a value of −45 to 45. For example, when the generation is the adult and the YawScore is −31 degrees (facing the right), the comment “Look at me, look at me, please!” is determined.

In the fourth step, the comment determination part 330 determines the comments with respect to the images IM2 in which there are two or three persons and the images IM3 in which there are four or more persons based on positional relation between persons. Specifically, the comment determination part 330 compares the relative sizes of the faces of the persons and determines the comment. In addition, with respect to the images IM1 in which there is one person, the fourth step is not performed.

FIG. 15 is a diagram for explaining a comment example based on the positional relation between the persons. In FIG. 15, an image of two subjects F1 and F2 who locate at the positions different in distance from the image capturing person is captured. The face area of the subject F1 near the image capturing person is large and the face area of the subject F2 far from the image capturing person is small. For example, when the generation of the subject F2 whose face area is small is the adult and the relative size of the face area of the subject F2 relative to that of the subject F1 (Relative Size) is equal to or smaller than 0.5, the comment “Would you please get closer?” is determined.

In the fifth step, with respect to the images IM3 in which there are four or more persons, the persons who are given the comments are identified. This is because the number of the added comments should be limited, and otherwise, the image itself is hardly to be seen when all the persons are given the comments in case where one subject image includes four or more persons. And due to the above-mentioned series of processes, the suitable comments according to the number of the subjects in the image and/or the aspect of the subjects are to be determined.

### (4-2. Acquisition Processing of Comment Display Time)

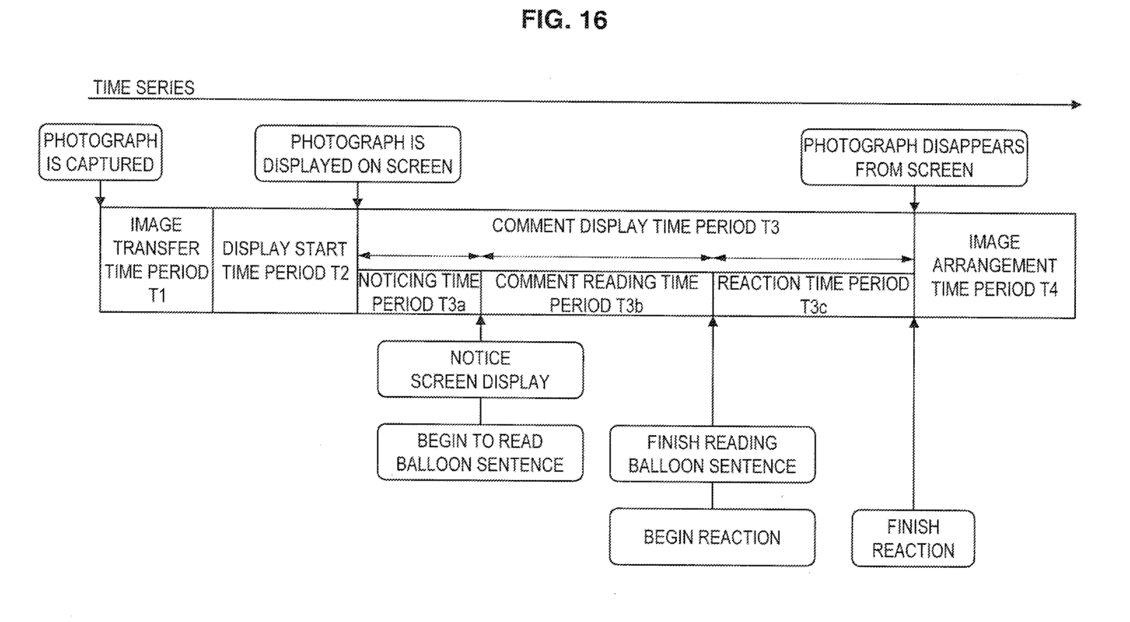

The specific acquisition processing of a display time of the subject image, to which the comments are added, performed by the display time acquisition part 350 is described specifically referring to FIG. 16 to FIG. 18.

FIG. 16 is a schematic diagram illustrating time periods from the subject image having been captured until it is arranged in the virtual three-dimensional space. As illustrated in FIG. 16, the time periods from the subject image having been captured until it is arranged in the virtual three-dimensional space include an image transfer time period T1, a display start time period T2, a comment display time period T3 and an image arrangement time period T4.

The image transfer time period T1 is a time period until the subject image captured by the image capturing apparatus 20 is transferred to the display apparatus 40. The display start time period T2 is a time period until the subject image which the display apparatus 40 has received is displayed on the display screen. For example, the display start time period T2 is a time period during which transition animation such as fade-in of the subject image or the like is performed.

The comment display time period T3 is a time period during which the comment is attached to the displayed subject image to display. The comment display time period T3 is constituted of a noticing time period T3a, a comment reading time period T3b and a reaction time period T3c.

The noticing time period T3a is a time period until the user notices that the subject image with a comment is displayed on the display screen. The noticing time period T3b may include a time during which the display screen switches and the user turns the face, for example.

The comment reading time period T3b is a time period during which the user begins to read the comment and finishes the reading.

The reaction time period T3c is a time period during which, after finishing the reading, the user takes a reaction. For example, the reaction time period T3c is a time period during which, after reading the comment, the user laughs, explains it pointing, or has a pleasant talk with other users. In addition, it is supposed that the above-mentioned user is the subject in the subject image. This is because the subject whose image is captured automatically sees the display screen on which the subject image obtained by capturing an image of the subject concerned is displayed, and takes the reaction in the party photographing function.

The image arrangement time period T4 is a time period from disappearance of the subject image to which the comment is attached from the display screen until the subject image concerned is arranged in the virtual three-dimensional space. For example, the image arrangement time period T4 is a time period during which transition animation such as fade-out of the subject image completes.

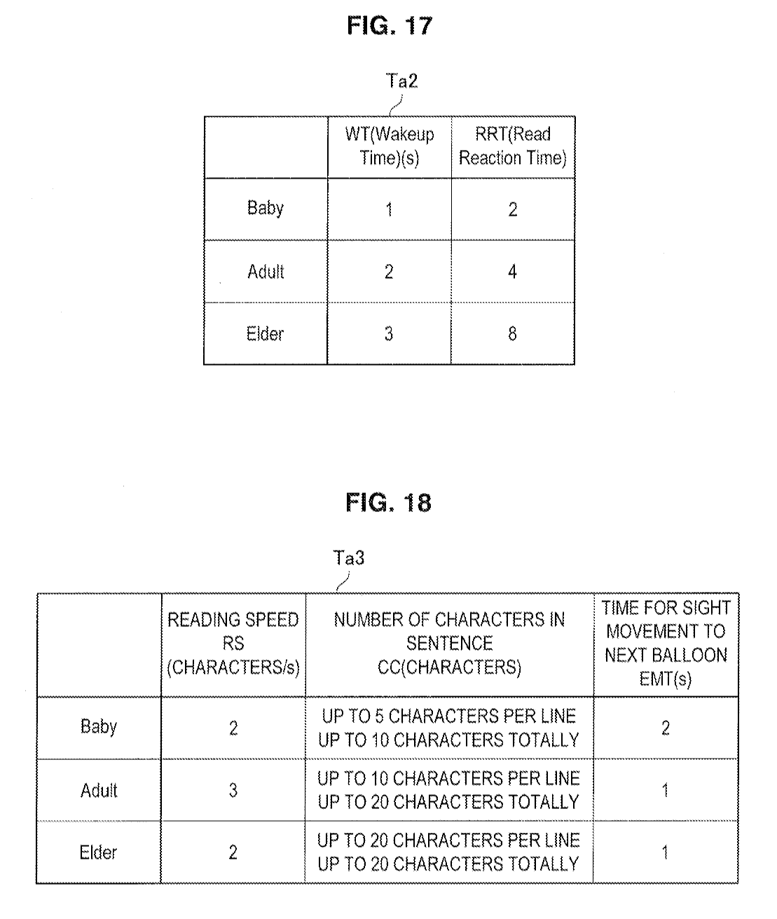

Next, a calculating method of the comment display time period T3 is described referring to FIG. 17 and FIG. 18. FIG. 17 is a table Tat which illustrates relation of the age bracket of the user with the noticing time period T3a and reaction time period T3c. FIG. 18 is a table Ta3 which illustrates relation of the age bracket of the user with the comment reading time period T2b.

As illustrated in FIG. 17, the noticing time period T3a is calculated based on constants according to the age brackets of the users. The noticing time period (WT: Wakeup Time) T3a becomes longer as the age bracket of the user becomes higher. For example, the noticing time period T3a of the child (Baby) is

1 (s), the noticing time period T3a of the adult (Adult) is

2 (s), and the noticing time period T3a of the elderly person (Elder) is

3 (s). The reason that the noticing time period T3b of the child (Baby) is the shortest is because a child tends to observe a display screen compared with other age brackets. In addition, such times are only examples and different values may be configured.

As illustrated in FIG. 18, also the comment reading time period T3b is calculated based on constants according to the age brackets of the users. Specifically, the comment reading time period (BRT: Balloon Reading Time) T3b is calculated by the following formula.

BRT=CC/RS+EMT

Herein, the CC (Character Count) is the number of characters in the text. The CC is configured to include the number of characters per line and the total number of characters according to the age brackets. The RS (Reading Speed) denotes the speed at which the user reads the text (the number of characters/s). The EMT (Eye Moving Time) is a time which is expected to move the viewpoint to another balloon. In addition, EMT is 0 (s) when there is one balloon.

For example, the comment reading time period T3b is (characters)/3 (characters/s)=3 (s) when the comment “Please smile more!” is attached to the image including the face of the adult.

As illustrated in FIG. 17, the reaction time period T3c is calculated based on constants according to the age brackets of the user. Also the reaction time period T3c becomes longer as the age bracket of the user becomes higher.

The display time acquisition part 350 acquires the comment display time period T3 by adding the noticing time period Tia, comment reading time period T3b and reaction time period T3c calculated as mentioned above. The display controller 340 displays the comments for the comment display time period T3 acquired by the display time acquisition part 350. Thus, since the display time is configured according to the age bracket and the like of the user, the user can grasp the comments appropriately.

### 5. OPERATION OF IMAGE DISPLAY SYSTEM IN PROCESSING COMMENT DISPLAY

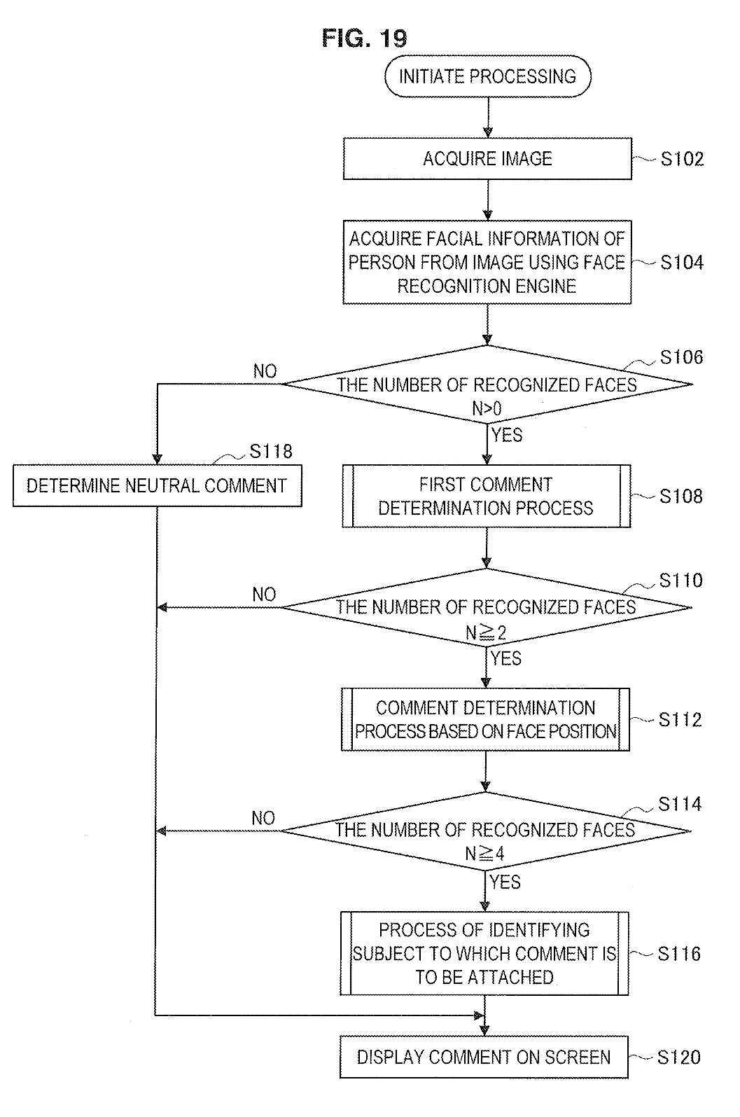

The comment display processing according to the subject is described referring to FIG. 19. FIG. 19 is a flowchart illustrating the comment display processing according to the subject in the images. The flowchart illustrated in FIG. 19 starts with the subject image being captured automatically by the image capturing apparatus 20.

The processing is realized by the CPU executing the program stored in the ROM. In addition, the executed program may be stored in a recording medium such as a CD (Compact Disk), a DVD (Digital Versatile Disk) and a memory card, and may be downloaded from a server or the like via the Internet.

First, the image acquisition part 310 acquires the subject image (Step S102). Next, the image analysis part 320 acquires facial information of the subject based on the acquired subject image (Step S104).

Next, the image analysis part 320 decides the number N of the faces based on the acquired facial information (Step S106). And when it is decided that the number N of the faces is one or more in Step S106 (Yes), the comment determination part 330 performs first comment determination process (Step S108).

### (5-1. First Comment Determination Process)

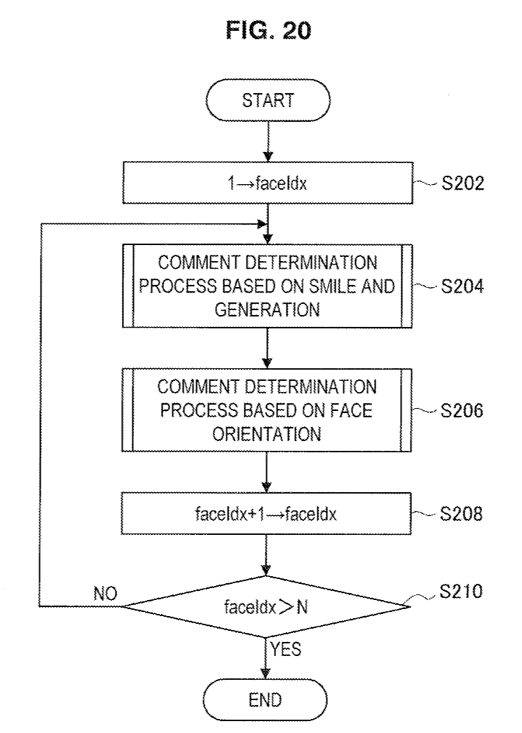

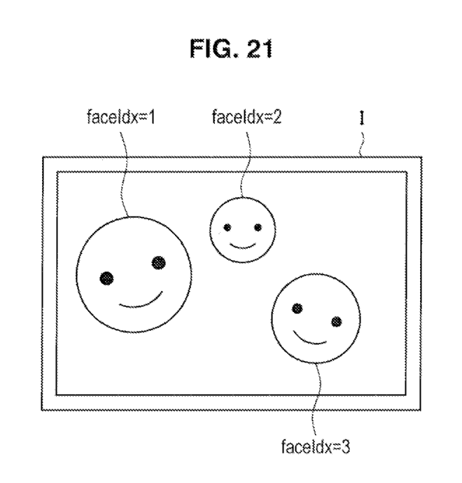

The first comment determination process in Step S108 is described referring to FIG. 20 and FIG. 21. FIG. 20 is a flowchart illustrating the first comment determination process. FIG. 21 is a schematic diagram illustrating the subjects of the comment determination object. In FIG. 21, a face F1 with faceldx=1, a face F2 with faceldx=2 and a face F3 with faceldx=3 as the faces of the comment determination object are indicated in one image.

First, the comment determination part 330 sets faceldx to 1 (Step S202). And the comment determination part 330 performs comment determination process based on smile and generation (Step S204).

### (5-1-1. Comment Determination Process Based on Smile and Generation)

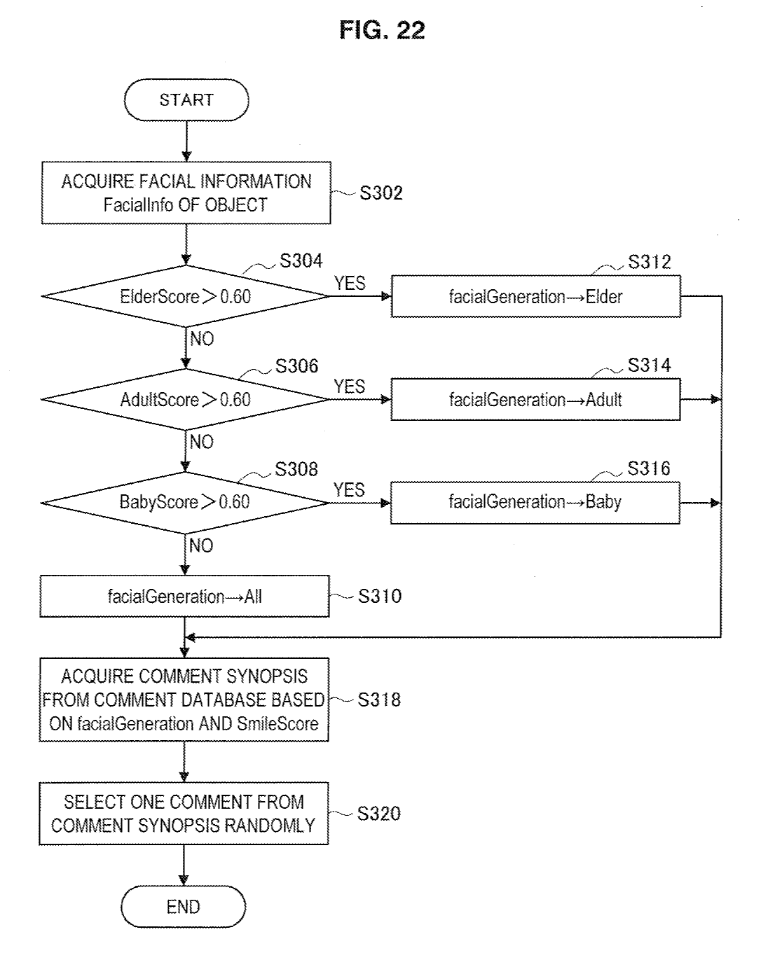

The comment determination process based on smile and generation is described referring to FIG. 22. FIG. 22 is a flowchart illustrating the comment determination process based on smile and generation.

First, the comment determination part 330 acquires facial information FacialInfo of the comment determination object (Step S302). Herein, it is supposed that facial information FacialInfo of the face F1 with faceldx=1 is acquired.

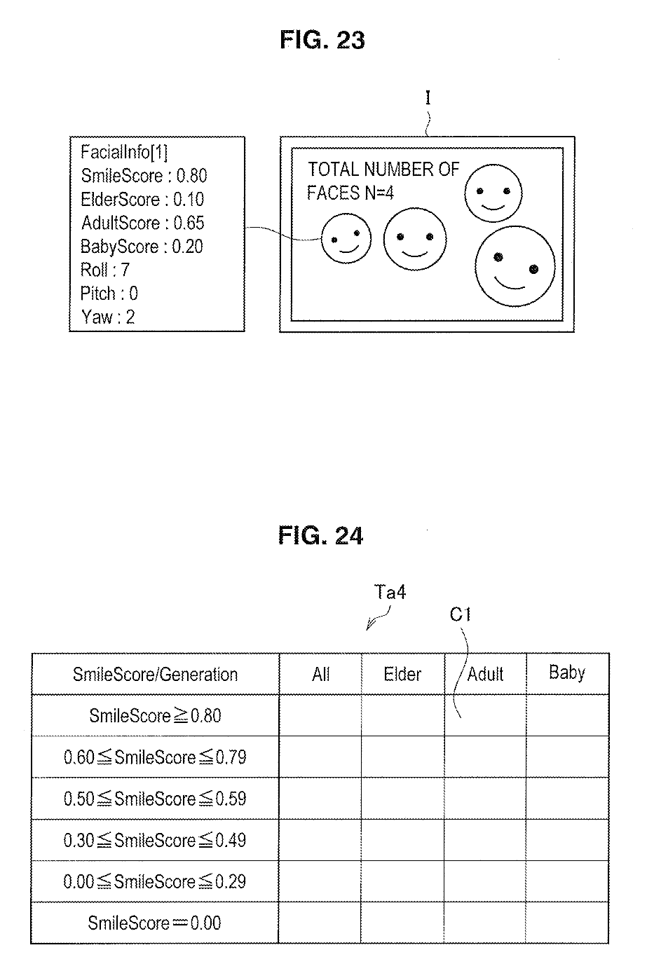

FIG. 23 is a schematic diagram for explaining the facial information FacialInfo. The facial information FacialInfo is configured for each face of the object, and in FIG. 23, the facial information FacialInfo of the face F1 with faceldx=1 is indicated. The facial information FacialInfo includes SmileScore, ElderScore, AdultScore, BabyScore and the like. Herein, SmileScore denotes the degree of the subject. ElderScore, AdultScore and BabyScore denote possibilities of relevancy corresponding to the elderly person, the adult and the child, respectively. Moreover, Roll, Pitch and Yaw denote the face orientations of the subject in the directions of the three axes which cross one another perpendicularly.

The comment determination part 330 decides whether or not ElderScore is larger than 0.60 (Step S304). And when it is decided that ElderScore is larger than 0.60 in Step S304 (Yes), the comment determination part 330 sets FacialGeneration (smile generation) to Elder (elderly person) (Step S312).

When it is decided that ElderScore is not larger than 0.60 (No) in Step S304, the comment determination part 330 decides whether or not AdultScore is larger than 0.60 (Step S306). And when it is decided that AdultScore is larger than 0.60 in Step S306 (Yes), the comment determination part 330 sets FacialGeneration to Adult (adult) (Step S314).

When it is decided that AdultScore is not larger than 0.60 in Step S306 (No), the comment determination part 330 decides whether or not BabyScore is larger than 0.60 (Step S308). And when it is decided that BabyScore is larger than 0.60 in Step S308 (Yes), the comment determination part 330 sets FacialGeneration to Baby (child) (Step S316).

When it is decided that BabyScore is not larger than 0.06 in Step S308 (No), the comment determination part 330 sets FacialGeneration to All (all the generations), the generation identified for neither Elder or Adult or Baby (Step S310).

Herein, since the facial information FacialInfo of the face F1 with faceldx=1 illustrated in FIG. 23 represents AdultScore being 0.65, the comment determination part 330 sets FacialGeneration of the face F1 to Adult.

Next, the comment determination part 330 acquires a comment synopsis from a comment database illustrated in FIG. 24 based on the set FacialGeneration and SmileScore of the facial information FacialInfo (Step S318).

FIG. 24 is a table Ta4 illustrating a comment database. As illustrated in FIG. 24, in the comment database, the comments are categorized by SmileScore and Generation. For example, since FacialGeneration of the face F1 is Adult and SmileScore thereof is 0.80, the comment determination part 330 selects the comment synopsis of the section C1 for which 0.80≦SmileScore and Generation is Adult in the comment database.

Next, the comment determination part 330 selects one comment from the acquired comment synopsis randomly (Step S320). Thereby, the comment determination process based on smile and generation regarding the face F1 with faceldx=1 is completed, and the process returns to the flowchart illustrated in FIG. 20. Then, the comment determination part 330 performs comment determination process based on face orientation on the face F1 with faceldx=1 (Step S206).

### (5-1-2. Comment Determination Process Based on Face Orientation)

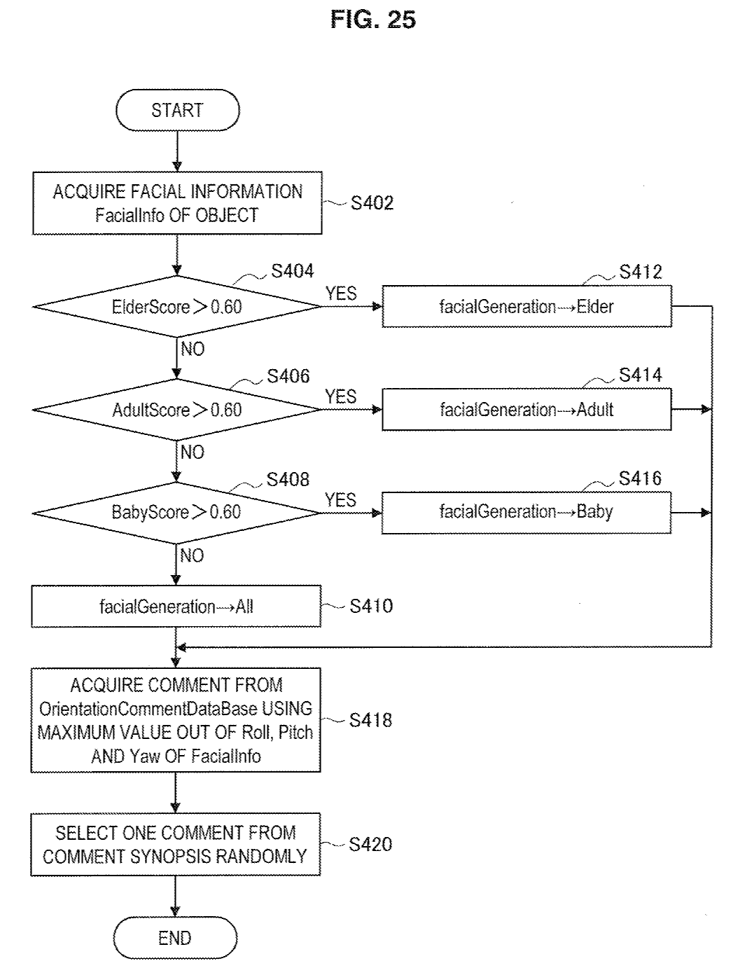

The comment determination process based on face orientation is described referring to FIG. 25. FIG. 25 is a flowchart illustrating the comment determination process based on face orientation.

First, the comment determination part 330 acquires facial information FacialInfo of the comment determination object (Step S402). Herein, it is supposed that the facial information FacialInfo of the face F1 with faceldx=1 is acquired.

Next, the comment determination part 330 sets FacialGeneration based on ElderScore, AdultScore and BabyScore of the facial information FacialInfo (Steps S404 to S416). These processes are similar to Steps S304 to S316 in the above-mentioned comment determination process based on smile and generation, and the comment determination part 330 sets FacialGeneration of the face F1 to Adult.

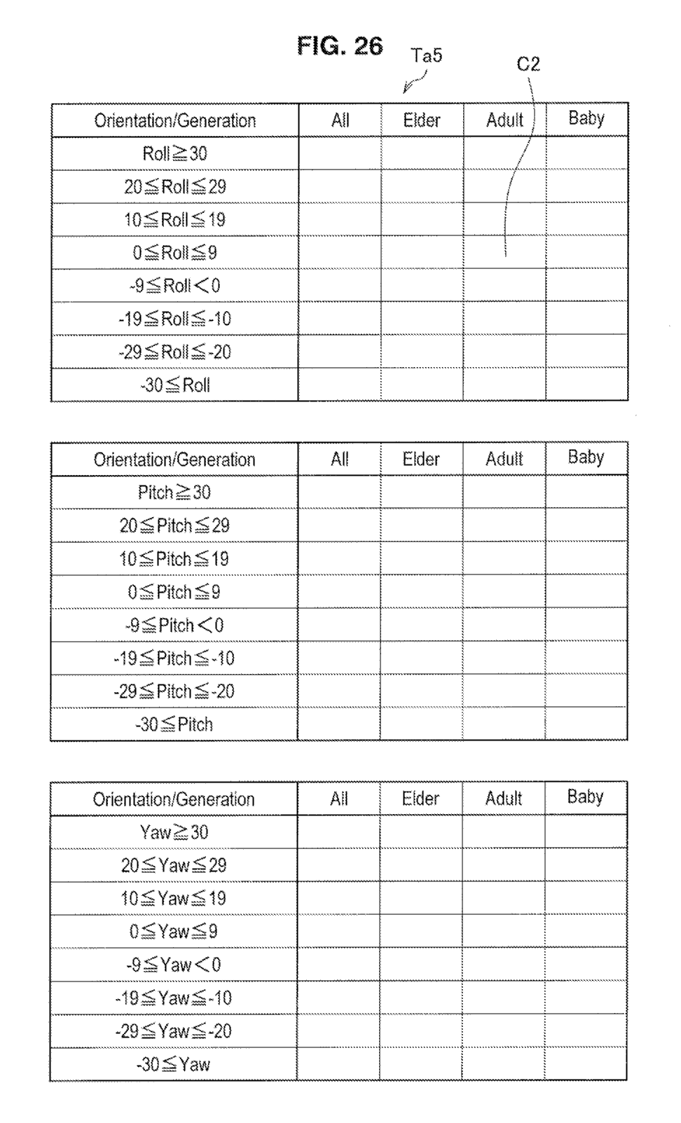

Next, the comment determination part 330 acquires a comment synopsis from a comment database illustrated in FIG. 26 using FacialGeneration thus set and a maximum value out of Roll, Pitch and Yaw of the facial information FacialInfo (Step S418).

FIG. 26 is tables Tay illustrating a comment database. As illustrated in FIG. 26, in the comment database, the comments are categorized by face orientations (Orientation) and Generation. For example, since FacialGeneration of the face F1 is Adult and Roll is the maximum value (7), the comment determination part 330 selects the comment synopsis of the section C2 for which 0<Roll<9 and Generation is Adult in the comment database.

Next, the comment determination part 330 selects one comment from the acquired comment synopsis randomly (Step S420). Thereby, the comment determination process based on face orientation regarding the face F1 with faceldx=1 is completed, and the process returns to the flowchart illustrated in FIG. 20.

After the determination processing of the comment based on smile and generation and the comment based on face orientation for the face F1 with faceldx=1 is completed, the comment determination part 330 increments faceldx by 1 (Step S208). Then, the comment determination part 330 decides whether or not the faceldx value after the increment is larger than the number N of the recognized faces (Step S210).

When it is decided that the faceldx value is not larger than N in Step S210 (No), the comment determination part 330 repeats the processes in Steps S204 to S208 mentioned above. Namely, the comment determination part 330 performs the determination processing of the comment based on smile and generation and the comment based on face orientation for each of the face F2 with faceldx=2 and the face F3 with faceldx=3 illustrated in FIG. 21.

When it is decided that the faceldx value is larger than N in Step S210 (Yes), the first comment determination process is completed, and the process returns to the flowchart illustrated in FIG. 19.

The comment determination part 330 decides whether or not the number N of the faces recognized in Step S104 is equal to or greater than 2 (Step S110). Then, when it is decided that the number N of the faces is equal to or greater than 2 in Step S110 (Yes), the comment determination part 330 performs comment determination process based on face position (Step S112).

### (5-2. Comment Determination Process Based on Face Position)

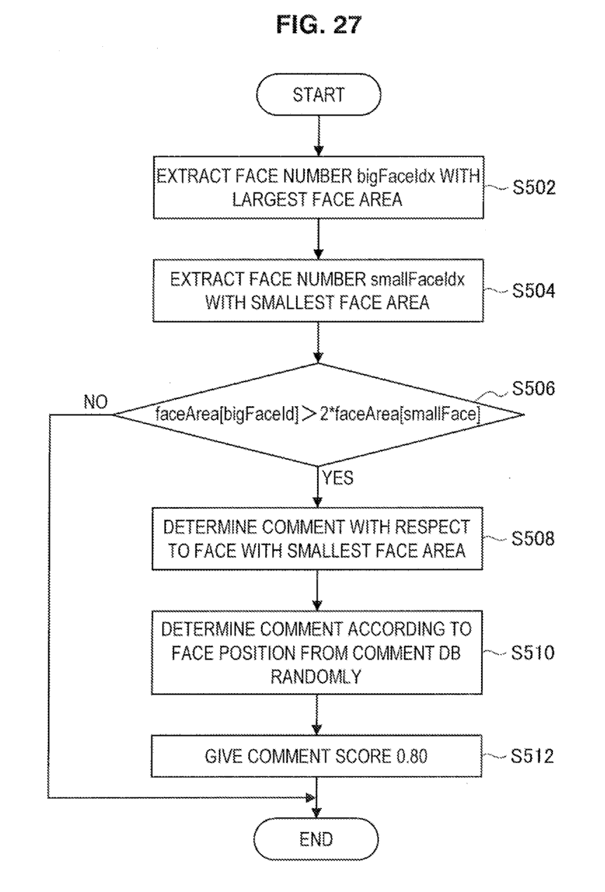

The comment determination process based on face position in Step S112 is described referring to FIG. 27. FIG. 27 is a flowchart illustrating the comment determination process based on face position.

First, the comment determination part 330 extracts a face number bigFaceldx with the largest face area (Step S502). Next, the comment determination part 330 extracts a face number smallFaceldx with the smallest face area (Step S504).

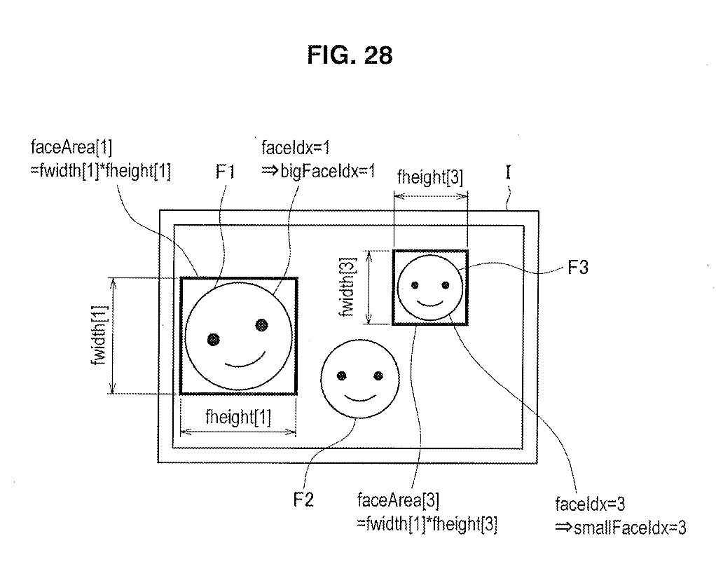

FIG. 28 is a schematic diagram for explaining extraction of the face numbers. The size of the face of the subject (face area) is proportional to the distance from the image capturing apparatus 20. Namely, the position of the face with a large face area is a position near the image capturing apparatus 20, and the position of the face with a small face area is a position distant from the image capturing apparatus 20. The face area (faceArea) is calculated by multiplying a width (fwidth) and height (fheight). In FIG. 28, the face with the largest face area is a face F1 with faceldx=1, and the face with the smallest face area is a face F3 with faceldx=3. Therefore, the face number bigFaceldx=1 and the face number smallFaceldx=3.

Next, the comment determination part 330 decides whether or not the face area with face number bigFaceldx is larger than the twice of the face area with face number smallFaceldx (Step S506). Then, when it is decided that the face area with face number bigFaceldx is larger than the twice of the face area with face number smallFaceldx in Step S506 (Yes), the comment determination part 330 configures to determine the comment with respect to the face with face number smallFaceldx (herein, the face F3 with faceldx=3) (Step S508).

Next, the comment determination part 330 determines, with respect to the face with face number smallFaceldx, the comment according to the face position from the comment database randomly (Step S510). Next, the comment determination part 330 gives a comment score 0.80 to the face with face number smallFaceldx (Step S512) to complete the comment determination process based on face position.

In addition, when it is decided that the face area with face number bigFaceldx is not larger than the twice of the face area with face number smallFaceldx in Step S506 (No), the comment determination part 330 completes the process, without determining a comment. And upon the completion, the process returns to the flowchart illustrated in FIG. 19.

The comment determination part 330 decides whether or not the number N of the faces recognized in Step S104 is equal to or greater than 4 (Step S114). Then, when it is decided that the number N of the faces is equal to or greater than 4 in Step S114 (Yes), the comment determination part 330 performs identification processing of the subject to which the comment is attached (Step S116).

### (5-3. Identification Processing of Subject to Which Comment is Attached)

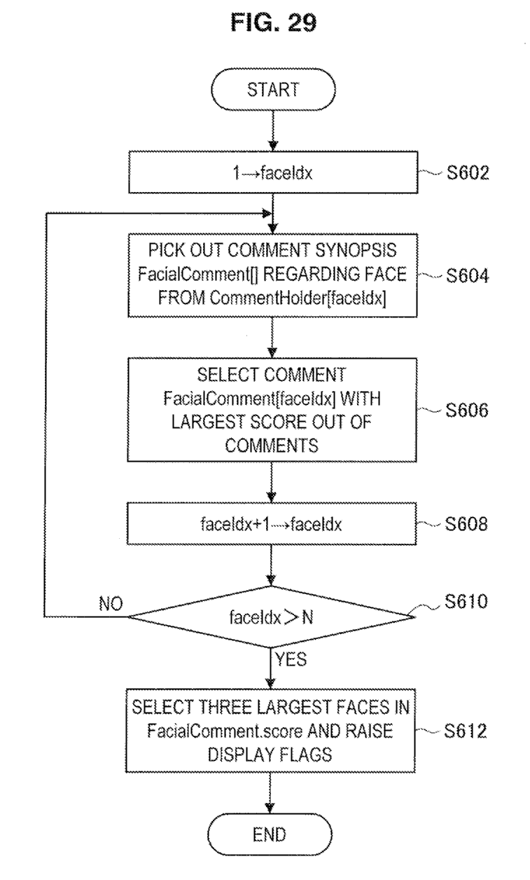

The identification processing of the subject to which the comment is attached in Step S116 is described referring to FIG. 29. FIG. 29 is a flowchart illustrating the identification processing of the subject to which the comment is attached.

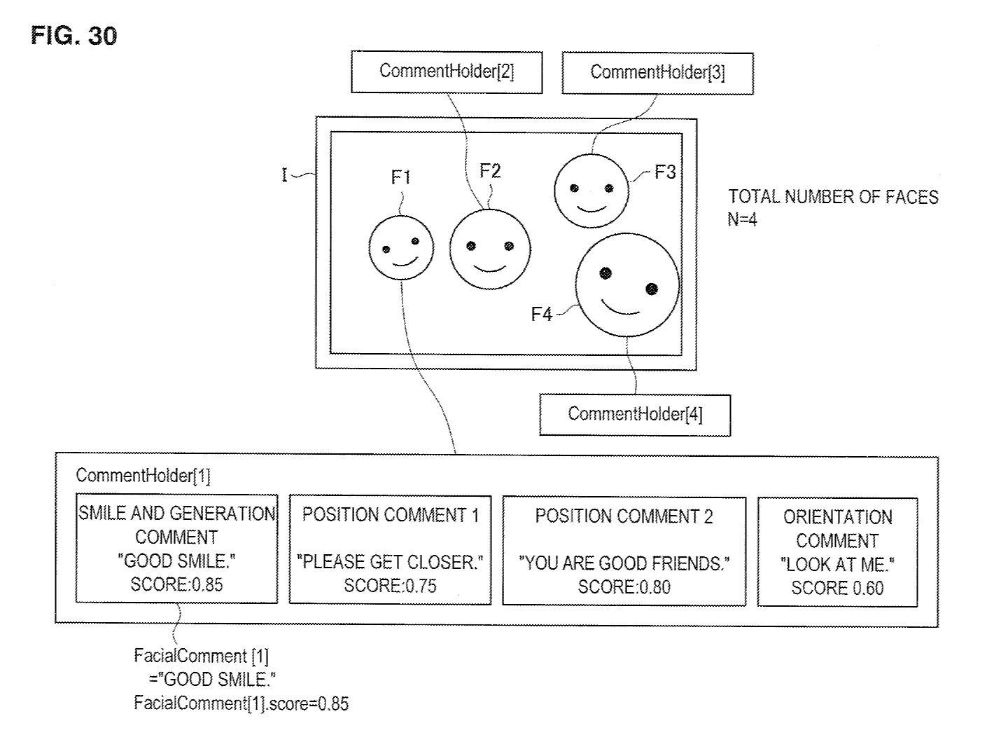

First, the comment determination part 330 sets faceldx to 1 (Step S602). Next, the comment determination part 330 picks out a comment synopsis FacialComment[ ] regarding a face F1 with faceldx=1 illustrated in FIG. 30 from CommentHolder[faceldx] (Step S604).

FIG. 30 is a schematic diagram for explaining CommentHolder[faceldx]. As illustrated in FIG. 30, CommentHolder[faceldx] is set for each face. And CommentHolder[faceldx] includes FacialComment (smile and generation comment, position comment 1, position comment 2 and orientation comment).

Next, the comment determination part 330 selects the comment which has a comment with the largest score out of four kinds of FacialComment thus picked out (Step S606). Since the smile and generation comment has the largest score in FIG. 30, the comment determination part 330 selects the smile and generation comment (“Good smile.”).

Next, the comment determination part 330 increments faceldx by 1 (Step S608). Then, the comment determination part 330 decides whether or not the faceldx value after the increment is larger than the number N of the recognized faces (Step S610).

When it is decided that the faceldx value is not larger than N in Step S610 (No), the comment determination part 330 repeats the processes in Steps S602 to S608 mentioned above. Namely, the comment determination part 330 selects the comment with the largest score out of the four faces illustrated in FIG. 30.

When it is decided that the faceldx value is larger than N in Step S610 (Yes), the comment determination part 330 selects the faces with the three largest scores out of the four faces, and sets display flags to them (Step S612). Thereby, the identification processing of the subject to which the comment is attached is completed, and the process returns to the flowchart illustrated in FIG. 19.

The display controller 340 displays balloons including the comments on the display screen (Step S120). The display controller 340 displays the balloons regarding the three faces to which the display flags are set in Step S612 in FIG. 29, for example.

In addition, when it is decided that the number N of the faces recognized in Step S106 is 0 (No), the comment determination part 330 determines a neutral comment (Step S118). Then, the display controller 340 displays the determined neutral comment on the display screen (Step S120).

Moreover, when it is decided that the number N of the faces recognized in Step S110 is less than 2 (No), the display controller 340 displays, for each face, the comment with a higher score out of the smile and generation comment and orientation comment. Thereby, the comment display processing according to the subject is completed.

### 6. CONCLUSION

As mentioned above, the information processing apparatus according to the present disclosure analyzes an image capturing aspect of a subject in an acquired subject image, and determines, with respect to the image capturing aspect, a comment added to the subject image to be displayed on a display screen based on an analysis result. Thereby, the subject sees the comment displayed on the display screen and changes the image capturing aspect, for example. By doing so, since composition of the subject will be changed in which composition an image is to be captured and displayed after that, the display which is rich in ideas can be performed.

As above, preferred embodiments of the present disclosure are described in detail with reference to the appended drawings, whereas the technical scope of the present disclosure is not limited to such examples. It should be understood by those skilled in the art that various modifications, combinations, sub-combinations and alterations may occur depending on design requirements and other factors insofar as they are within the scope of the appended claims or the equivalents thereof and that they naturally belong to the technical scope of the present disclosure.

In addition, the image acquisition part 310, image analysis part 320 and comment determination part 330 illustrated in FIG. 9 are realized due to functions of the control part 210 of the display apparatus 40 in the above, whereas they are not limited to this. For example, the server illustrated in FIG. 3 may be the information processing apparatus including the image acquisition part 310, image analysis part 320 and comment determination part 330. Namely, the server 70 analyzes an image capturing aspect of a subject in an acquired subject image, and determines, with respect to the image capturing aspect, a comment added to the subject image to be displayed on a display screen based on an analysis result. In such case, information on the comment determined in the server 70 is transmitted to the display apparatus 40, and the display apparatus 40 displays both the subject image and comment based on the received information on the comment.

Moreover, the steps illustrated in the flowcharts of the above-mentioned embodiments include, needless to say, processes performed in a time-series manner in the described order, and also processes performed in parallel or individually unnecessarily in a time-series manner. Moreover, it is not expected to be overemphasized that even steps processed in a time-series manner can be changed in terms of the processing order suitably in some cases.

The processes performed by the display control apparatus described in the present specification may be realized using any of software, hardware and a combination of software and hardware. Programs constituting the software are beforehand stored in a recording medium provided in the inside or outside of each apparatus, for example. Then, each program is read into a RAM (Random Access Memory) in execution and is executed by a processor such as a CPU, for example.

Additionally, the present technology may also be configured as below.

(1) An information processing apparatus comprising:

an image acquisition part acquiring a subject image obtained by capturing an image of a subject;

an image analysis part analyzing an image capturing aspect of the subject in the subject image acquired by the image acquisition part; and

a comment determination part determining, with respect to the image capturing aspect, a comment which is added to the subject image and displayed on a display screen based on an analysis result of the image analysis part.

(2) The information processing apparatus according to (1), further comprising:

a display controller adding and displaying the comment determined by the comment determination part to the subject image when displaying the subject image on the display screen.

(3) The information processing apparatus according to (1) or (2), wherein

the image capturing aspect includes a smile score of the subject, and

the comment determination part determines the comment according to the smile score.

(4) The information processing apparatus according to any one of (1) to (3), wherein

the subject image is an image obtained by capturing images of a plurality of the subjects,

the image capturing aspect includes positional relation among the plurality of subjects, and

the comment determination part determines the comment according to the positional relation when the positional relation is within a predetermined range.

(5) The information processing apparatus according to any one of (1) to (4), wherein

the image capturing aspect includes an orientation to which the subject faces, and

the comment determination part determines the comment according to the orientation.

(6) The information processing apparatus according to any one of (1) to (5), wherein

the image analysis part decides an age of the subject or to which one of a plurality of categorized age brackets the age corresponds, and

the comment determination part determines the comment according to the age of the subject or the age bracket to which the subject corresponds.

(7) The information processing apparatus according to any one of (1) to (6), wherein

the subject image is an image obtained by capturing images of a plurality of the subjects,

the comment determination part determines the comments for the respective subjects in the subject image, and

the display controller performs addition and display of the determined plurality of the comments for the respective corresponding subjects.

(8) The information processing apparatus according to any one of (1) to (7), wherein

the image capturing aspect includes a plurality of aspects, and

the comment determination part

converts degrees of the plurality of aspects into individual scores, and

determines the comment in relation to the aspect largest in the score out of the plurality of aspects.

(9) The information processing apparatus according to any one of (1) to (8), wherein

the comment determination part further determines a comment to the subject side or a comment from the subject side with respect to the image capturing aspect.

(10) The information processing apparatus according to (9), further comprising

a display controller adding and displaying the comment determined by the comment determination part to the subject image when displaying the subject image on the display screen, wherein

the display controller

adds and displays a balloon surrounding the comment to the subject image,

displays the balloon such that a reference point of the balloon locates outside the subject image within the display screen in case of a comment to the subject side, and

displays the balloon such that a reference point of the balloon locates inside the subject image within the display screen in case of a comment from the subject side.

(11) The information processing apparatus according to any one of (1) to (10), further comprising

a display time acquisition part acquiring a display time for which the comment determined by the comment determination part is added to the subject image to be displayed.

(12) The information processing apparatus according to (11), wherein

the image analysis part decides an age of the subject or to which one of a plurality of categorized age brackets the age corresponds, and

the display time acquisition part acquires the display time according to the age of the subject or the age bracket to which the subject corresponds.

(13) The information processing apparatus according to (11) or (12), wherein

the display time is a time obtained by adding

a first time until a user who sees the display screen notices the displayed comment,

a second time for which the user reads the comment, and

a third time for which the user performs reaction with respect to the comment.

(14) The information processing apparatus according to any one of (1) to (13), wherein

the display controller draws the subject image, to which the comment is added, at a predetermined drawing position in a virtual space which has a time axis corresponding to the image capturing date and time in a radius direction of a circle with a center at a viewpoint of a user, and has an orientation axis corresponding to the image capturing position in a circumferential direction of the circle.

(15) An information processing method comprising:

acquiring a subject image obtained by capturing an image of a subject;

analyzing an image capturing aspect of the subject in the acquired subject image; and

determining, with respect to the image capturing aspect, a comment which is added to the subject image and displayed on a display screen based on an analysis result.

(16) A program causing a computer to execute:

acquiring a subject image obtained by capturing an image of a subject;

analyzing an image capturing aspect of the subject in the subject image acquired; and

determining, with respect to the image capturing aspect, a comment which is added to the subject image and displayed on a display screen based on an analysis result.

The present disclosure contains subject matter related to that disclosed in Japanese Priority Patent Application JP 2011-243390 filed in the Japan Patent Office on Nov. 7, 2011, the entire content of which is hereby incorporated by reference.

What is claimed is:

1. An information processing apparatus comprising:
an image acquisition part acquiring a subject image obtained by capturing an image of a subject;
an image analysis part analyzing an image capturing aspect of the subject in the subject image acquired by the image acquisition part; and
a comment determination part determining, with respect to the image capturing aspect, a comment which is added to the subject image and displayed on a display screen based on an analysis result of the image analysis part.

2. The information processing apparatus according to claim 1, further comprising:
a display controller adding and displaying the comment determined by the comment determination part to the subject image when displaying the subject image on the display screen.

3. The information processing apparatus according to claim 1, wherein
the image capturing aspect includes a smile score of the subject, and
the comment determination part determines the comment according to the smile score.

4. The information processing apparatus according to claim 1, wherein
the subject image is an image obtained by capturing images of a plurality of the subjects,
the image capturing aspect includes positional relation among the plurality of subjects, and
the comment determination part determines the comment according to the positional relation when the positional relation is within a predetermined range.

5. The information processing apparatus according to claim 1, wherein
the image capturing aspect includes an orientation to which the subject faces, and
the comment determination part determines the comment according to the orientation.

6. The information processing apparatus according to claim 1, wherein
the image analysis part decides an age of the subject or to which one of a plurality of categorized age brackets the age corresponds, and
the comment determination part determines the comment according to the age of the subject or the age bracket to which the subject corresponds.

7. The information processing apparatus according to claim 1, wherein
the subject image is an image obtained by capturing images of a plurality of the subjects,
the comment determination part determines the comments for the respective subjects in the subject image, and
the display controller performs addition and display of the determined plurality of the comments for the respective corresponding subjects.

8. The information processing apparatus according to claim 1, wherein
the image capturing aspect includes a plurality of aspects, and
the comment determination part
converts degrees of the plurality of aspects into individual scores, and
determines the comment in relation to the aspect largest in the score out of the plurality of aspects.

9. The information processing apparatus according to claim 1, wherein
the comment determination part further determines a comment to the subject side or a comment from the subject side with respect to the image capturing aspect.

10. The information processing apparatus according to claim 9, further comprising
a display controller adding and displaying the comment determined by the comment determination part to the subject image when displaying the subject image on the display screen, wherein
the display controller
adds and displays a balloon surrounding the comment to the subject image,
displays the balloon such that a reference point of the balloon locates outside the subject image within the display screen in case of a comment to the subject side, and
displays the balloon such that a reference point of the balloon locates inside the subject image within the display screen in case of a comment from the subject side.

11. The information processing apparatus according to claim 1, further comprising
a display time acquisition part acquiring a display time for which the comment determined by the comment determination part is added to the subject image to be displayed.

12. The information processing apparatus according to claim 11, wherein
the image analysis part decides an age of the subject or to which one of a plurality of categorized age brackets the age corresponds, and
the display time acquisition part acquires the display time according to the age of the subject or the age bracket to which the subject corresponds.

13. The information processing apparatus according to claim 11, wherein
the display time is a time obtained by adding
a first time until a user who sees the display screen notices the displayed comment,
a second time for which the user reads the comment, and
a third time for which the user performs reaction with respect to the comment.

14. The information processing apparatus according to claim 1, wherein
the display controller draws the subject image, to which the comment is added, at a predetermined drawing position in a virtual space which has a time axis corresponding to the image capturing date and time in a radius direction of a circle with a center at a viewpoint of a user, and has an orientation axis corresponding to the image capturing position in a circumferential direction of the circle.

15. An information processing method comprising:
acquiring a subject image obtained by capturing an image of a subject;
analyzing an image capturing aspect of the subject in the acquired subject image; and
determining, with respect to the image capturing aspect, a comment which is added to the subject image and displayed on a display screen based on an analysis result.

16. A program causing a computer to execute:
acquiring a subject image obtained by capturing an image of a subject;
analyzing an image capturing aspect of the subject in the subject image acquired; and
determining, with respect to the image capturing aspect, a comment which is added to the subject image and displayed on a display screen based on an analysis result.
